(19) United States
(12) Patent Application Publication
(10) Pub. No.: US 2002/0198829 A1
(43) Pub. Date: Dec. 26, 2002

(54) Modular business transactions platform

(75) Inventors: Keith Ludwig, Newfields, NH (US); David Armand Bennett, Portsmouth, NH (US); Gregory Ernest Park, Stratham, NH (US)

Correspondence Address: Edmund P. Pfleger, HAYES, SOLOWAY, HENNESSEY,, GROSSMAN & HAGE, P.C., 130W. Cushing Street, Tucson, AZ, 85701, US

(73) Assignee: Bottomline Technologies, Inc.

(21) Appl. No.: 09/825,220

(22) Filed: Apr. 3, 2001

(51) Int. Cl. G06F 17/60

(52) U.S. Cl. 705/40; 705/39

(57) ABSTRACT

In one embodiment, an electronic bill presentment and payment system consistent with the invention comprises at least one biller system and at least one payor system in communication with a payment processing system. The payment processing system comprises a database including global information relating to the biller system and the payor system, and an application server for storing at least one modular business object containing specified instructions to govern financial transactions between the biller system and the payor system based on the global information. The application server permits replacement of a business object with another modular business object containing other specified instructions using the same global information. In another embodiment, the business object contains specified instructions for modifying the global information, and the application server permits replacement of a business object with another modular business object containing other specified instructions for modifying the same global information. In method form, a method for electronic bill presentment and payment comprises: storing global information relating to a biller system and a payor system; storing at least one modular business object containing specified instructions to govern transactions between said biller system and said payor system based on said global information; permitting said biller system and/or payor system to access said at least one business object for executing a financial transaction; and permitting replacement of said business object with another modular business object containing other specified instructions using the same said global information.

### BACKGROUND OF THE INVENTION

The present invention relates to a financial transaction system and method, and more particularly, to a network-based system and method for billing and payment.

Recently, there has been an increase in the popularity of performing financial transactions using the Internet as a centralized network for linking the individual financial systems of a plurality of entities transacting business with one another. With the recent explosion in e-commerce, the increasing acceptance of the Internet as a less expensive and more efficient way of doing business, and the advent of new server technology and sophisticated online security systems, Internet-based financial transactions are becoming ever more common. Advantageously, an Internet-based financial transaction system for bill presentment and payment may reduce many of the transaction costs associated with other financial transaction systems, such as preparation costs, banking fees, and costs for clearing, reconciling and closing. Moreover, such a transaction system may seamlessly handle transactions from virtually any entity with Internet access, regardless of the nature of the business, geographic location, size, or trading currency, even those entities for which the costs of traditional invoicing, presentment and payment have traditionally been high.

Traditionally, invoice presentment and bill payment procedures have required a capital outlay for the equipment to prepare and distribute each invoice, as well as collect and reconcile payment of the invoice. Additionally, there are costs and collection delays associated with the multiple steps required between multiple parties to effect invoice presentment and bill payment. Such steps may include the payee's preparation and distribution of invoices by mail (which may take up to a week to reach payers) or electronically; one or more invoice approvals by individuals or departments within the payer's organization (e.g. a purchasing manager); invoice adjustment or dispute by other individuals or departments; payment authorizations by other individuals or departments; payment issuance, either electronically or by issuance of a paper instrument, such as a check, (again, typically by mail); receipt of payment at the payee's side, either by the payee, the payee's bank, a lockbox, or other payment receipt entity; and processing of the payment either at the payee's bank, at the payee's accounts receivable, or both. This entire process may take several weeks, and requires separate accounting records to be kept and harmonized at both the payer's (accounts payable) and payee's (accounts receivable) sides, and/or within other decentralized recordkeeping systems.

There are further costs and collection delays associated with any adjustments to the invoice that may be made by either the payer or the payee. When an adjustment is made within one recordkeeping system, the adjustment must be communicated to the other system(s) so that a corresponding adjustment can be made. For example, an invoice adjustment made by the payer results in the payer's entry of an adjusted invoice amount into its accounts payable, as well as the payer's mailing a copy of a manually-adjusted invoice to the payee, so that the payee can update its accounts receivable.

### SUMMARY OF THE INVENTION

In a system consistent with the invention, a plurality of modular business objects may be selectable by the user of a payer system for execution (e.g. invoice review, invoice adjustment, and invoice payment). The business objects may generate extensible markup language (XML) calls to a database interface, which may interact with the database and return XML responses to the business objects. Invoices may be batch loaded onto the database from biller systems, and payer systems may receive notification by e-mail that an invoice has been issued, so that they may subsequently effect payment electronically. Thus, multiple parties may no longer need to exchange paper or electronic documents for invoicing and payment. Instead, a financial transaction system consistent with the invention may allow payers and billers to view invoice data via either a standard web browser (in which case appropriate HTML/XML translations may be made) or a custom application, and to print paper documents derived from those records, as necessary, and use those electronic records to update individual accounting systems, depending on legacy or other requirements.

In one embodiment, an electronic bill presentment and payment system consistent with the invention comprises at least one biller system and at least one payer system in communication with a payment processing system. The payment processing system comprises a database including global information relating to the biller system and the payer system, and an application server for storing at least one modular business object containing specified instructions to govern financial transactions between the biller system and the payer system based on the global information. The application server permits replacement of a business object with another modular business object containing other specified instructions using the same global information.

In another embodiment, at least one business object contains specified instructions for modifying the global information, and the application server permits replacement of a business object with another modular business object containing other specified instructions for modifying the same global information.

In method form, a method for electronic bill presentment and payment comprises: storing global information relating to a biller system and a payer system; storing at least one modular business object containing specified instructions to govern financial transactions between said biller system and said payer system based on said global information; permitting said biller system and/or payer system to access said at least one business object for executing a financial transaction; and permitting replacement of said business object with another modular business object containing other specified instructions using the same said global information.

### BRIEF DESCRIPTION OF THE DRAWINGS

FIG. 1 is a block diagram of an electronic bill presentment and payment system consistent with the present invention;

FIG. 2 is a flowchart illustrating an exemplary fundamental operation of one of a plurality of web servers in one embodiment of the invention;

FIG. 3 is a flowchart illustrating an exemplary operation of the application server in one embodiment of the invention;

FIG. 4 is a flowchart illustrating an exemplary invoice loading operation in one embodiment of the invention;

FIG. 5 is a workflow diagram illustrating exemplary host user operations in one embodiment of the invention;

FIG. 6 is a workflow diagram illustrating exemplary biller system operations in one embodiment of the invention;

FIG. 7 is a workflow diagram illustrating exemplary biller system administration operations in one embodiment of the invention;

FIG. 8 is a workflow diagram illustrating exemplary payer system operations in one embodiment of the invention;

FIG. 9 is a workflow diagram illustrating exemplary payer system invoice/payment operations in one embodiment of the invention;

FIG. 10 is a workflow diagram illustrating exemplary payer system reporting operations in one embodiment of the invention; and

FIG. 11 is a workflow diagram illustrating exemplary payer system administration operations in one embodiment of the invention.

### DETAILED DESCRIPTION OF EXEMPLARY EMBODIMENTS

### Exemplary Bill Presentment and Payment System

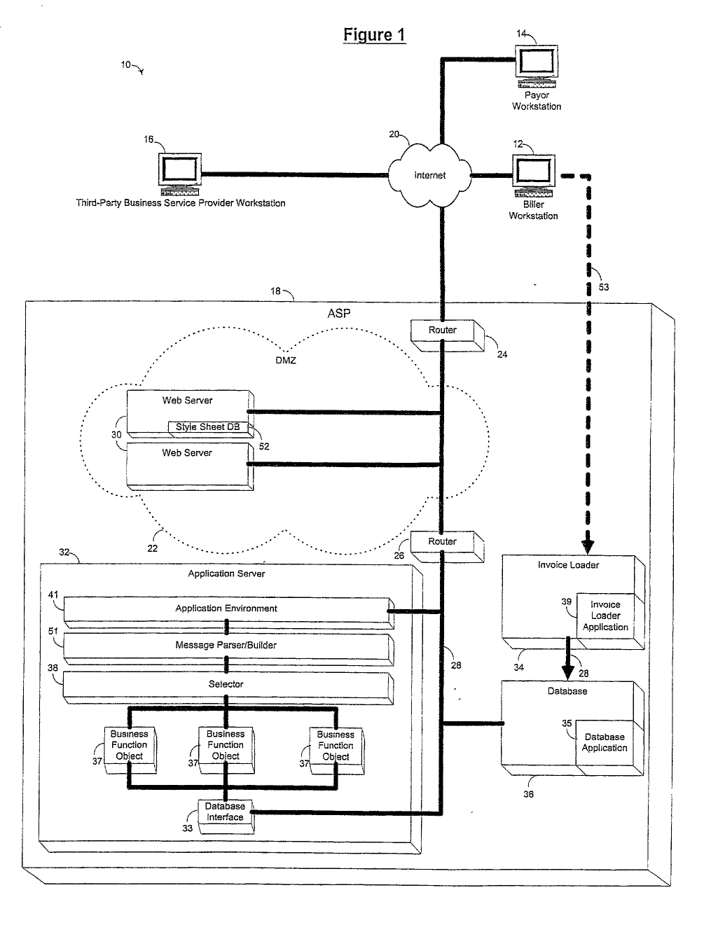

FIG. 1 illustrates an electronic bill presentment and payment system 10 consistent with the present invention. System 10 includes at least one biller system 12, at least one payer system 14, at least one business service provider system 16, and a payment processing system (“ASP”) 18, in communication with one another via a network 20. The network 20 may be a TCP/IP compliant network, such as the Internet. It should be appreciated that each of the biller system 12, payer system 14, business service provider system 16 and ASP 18 (also referred to herein as “workstations”) may be remotely located from each other and may be controlled by separate entities. Alternatively, permutations of each of the biller system 12, payer system 14, business service provider system 16 and ASP 18 may be commonly controlled and/or located at a single entity.

More specifically, the biller system 12 and payer system 14 may interface with the ASP 18 via a web browser or other TCP/IP compliant software. The biller system 12 and payer system 14 may comprise computing devices with appropriate network interface hardware and software for establishing a TCP/IP session with a web server 30 at the ASP 18 and for executing an application for interfacing with the web server 30. The application may be typical HTML Internet web browser software, such as Netscape Navigator™ or Microsoft Internet Explorer™, which is capable of receiving HTML documents from the web server 30 and returning HTTP posts to the web server 30. The application may alternatively be one or more direct real-time or batch-controlled interfaces accessing real-time TCP/IP or other network type sockets.

The business service provider system 16 may be an exchange or other service bureau application providing a plurality of business processing services to its clients (which may include the biller system 12 and/or payer system 14). One such business processing service may be electronic bill presentment and payment, as may be provided using a system and/or method consistent with the invention. In such a configuration, from the point of view of the service provider system 16, the ASP 18 may be a back end system for performing such bill presentment and payment portions of the overall services. The service provider system 16 may communicate with the ASP 18 utilizing data files with a predefined format to assure that the content of such data files may be recognized by the intended hardware and/or software. In one embodiment, the predefined format is an extensible markup language (XML) schema and the data files are XML messages. Utilizing the Internet 20, the service provider system 16 and the ASP 18 may establish a TCP/IP session and exchange XML messages.

It should be appreciated that, in an alternative embodiment, a biller system 12 or a payer system 14 may operate an accounting system interface application rather than a web browser. In this case, the biller system 12 or payer system 14 will communicate with the ASP 18 utilizing XML messages, and the XML communication may be similar to that which may occur between the ASP 18 and the service provider system 16. Such an accounting system interface application may enable the biller system 12 or payer system 14 to avoid manually reading data from an HTML document and manually re-entering into an accounting system. More specifically, the XML messages may be used to directly input content into the accounting system or, at a minimum, automatically populate content onto an accounting system data entry screen.

One or more web servers 30 may be located in a secured zone 22 between two routers 24, 26 serving as firewalls, one for protecting the internal private network 28 of the ASP 18 and one for blocking unauthorized Internet access. This zone 22 is often referred to idiomatically as a DMZ (i.e. “de-militarized zone”). It is noted that one or more firewalls may be placed between any one of a number of components of the present invention for security purposes. In this standard firewall configuration of a DMZ 22, the web servers 30 may be coupled to the Internet 20 by a first router 24 and coupled to a private network 28 by a second router 26. On the “front end”, the web servers 30 may establish the TCP/IP sessions and communicate with the biller systems 12, payer systems 14, and business service provider systems 16, as described above. On the back end, the web servers 30 may use XML messages to make remote processing calls (RPCs) to an application server 32 (described hereinbelow in further detail) and may receive XML response messages to such calls. An invoice loader 34 (described hereinbelow in further detail) may be provided for transmitting batch input to a database server 36, which may store invoice and other financial, transactional, or non-financial data. Those skilled in the art will recognize that such data may be generated by one of any number of billing systems, e.g., SAP, Oracle Financials, JD Edwards, People Soft, Great Plains, etc. The data outputted by these billing systems and input into the system may come in a variety of formats including raw data, print file format, and X-12 ANSI 810 (EDI). The database server 36 may include a database application 35 (described hereinbelow in further detail) for reading and writing to the raw data stored on the magnetic media of the database.

### Web Server

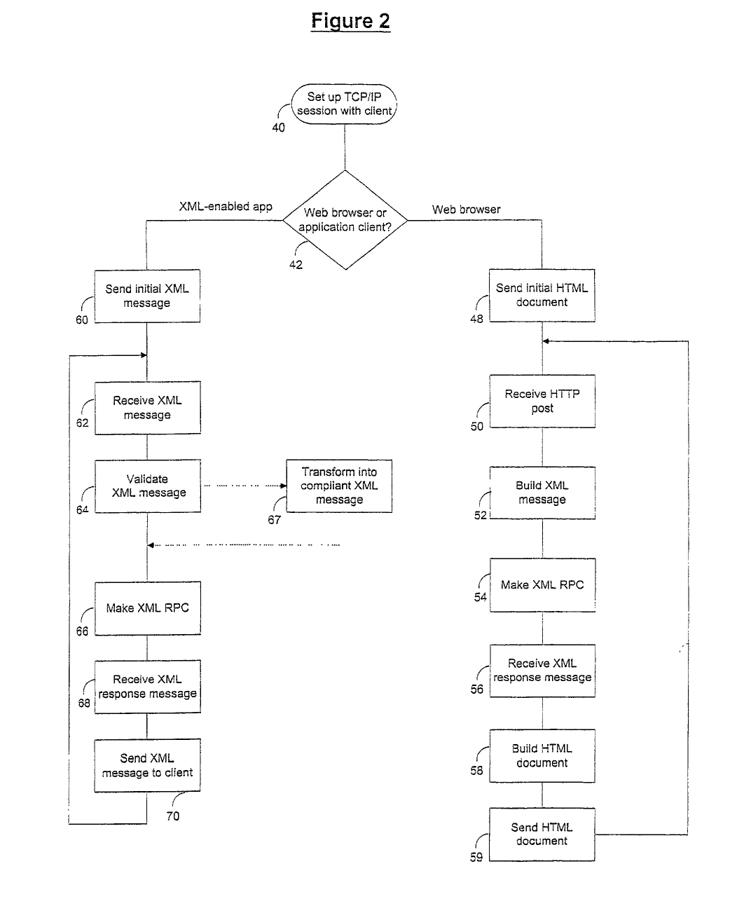

With reference to the flowchart of FIG. 2 in conjunction with FIG. 1, an exemplary fundamental operation of a web server 30 in accordance with one embodiment of this invention is shown. A TCP/IP session may be established at step 40 with a remote client, which includes appropriate exchanges of passwords and/or other authentication messages to verify that the remote client has authorized access. Clients may be either workstations which interface with the server 30 using a browser interface, or, alternatively, software clients which interface with the server 30 using XML messages. Step 42 represents a determination as to whether the remote client is operating a web browser or whether the client is operating an XML enabled application. If the remote client is operating a web browser, the server 30 may send out an initial HTML document to the client at step 48. This initial document may be the main menu page that the operator at the remote client might expect to see immediately after logging onto the system utilizing the browser. The server may then receive an HTTP post from the remote client at step 50 and, in response to such HTTP post, build an XML message for making a remote processing call to the application server 32 at step 52. More specifically, the XML message is based on the content of the post and a predetermined schema for the function that the operator of the remote client has requested via the HTTP post. For example, if the operator had selected to view a list of open invoices from the HTML menu document, the server might build an XML message for requesting open invoices from the application server 32 based on the schema for viewing a list of open invoices in response to the HTTP post.

Step 54 represents the server making an XML remote processing call to the application server 32 utilizing the XML message. An XML response message may be received back from the application server 32 at step 56. The web server may then utilize the content of the XML response message to build an HTML document to send to the remote client in response to the remote client's HTTP post at step 58. More specifically, each web server 30 may include a style sheet database 52 that stores style sheets for various documents that may be sent to remote clients and may provide different style sheets for the same document based on different clients. As such, the branding, look and feel, and layout of documents may be varied on a client-by-client basis. The step of building an HTML document may therefore also include selecting a style sheet corresponding to the remote client and combining the style sheet with the content of the XML response message to build the HTML document. The HTML document may then be sent to the remote client at step 59, and, returning to step 50, another HTTP post may be received and the foregoing steps repeated for that HTTP post.

Alternatively, if at step 42 the remote client is determined to be a client utilizing an XML enabled application instead of a web browser, the web server may send an initial XML message to the remote client at step 60. The web server may then receive an XML message from the remote client at step 62 and validate the XML message at step 64. If necessary, the content may be transformed into an XML message compliant with the schema needed for making a remote processing call to the application server at step 67 if it did not validate at step 64.

The schema-compliant XML message may then be used to make the remote processing call to the application server at step 66. At step 68, a response XML message may be received from the application server, and, at step 70, the response XML message may be returned to the remote client. Thereafter, returning to step 62, another XML message may be received and the foregoing steps may be repeated.

It should be appreciated that the above description represents an exemplary process utilized for interacting with each remote client. In operation, the server may be operating with a plurality of remote clients simultaneously and/or utilizing a multi-tasking based operating environment. Furthermore, a plurality of web servers 30, each communicating with a plurality of different clients, may each be capable of making XML calls to the application server 32 to perform the above described functions.

### Application Server

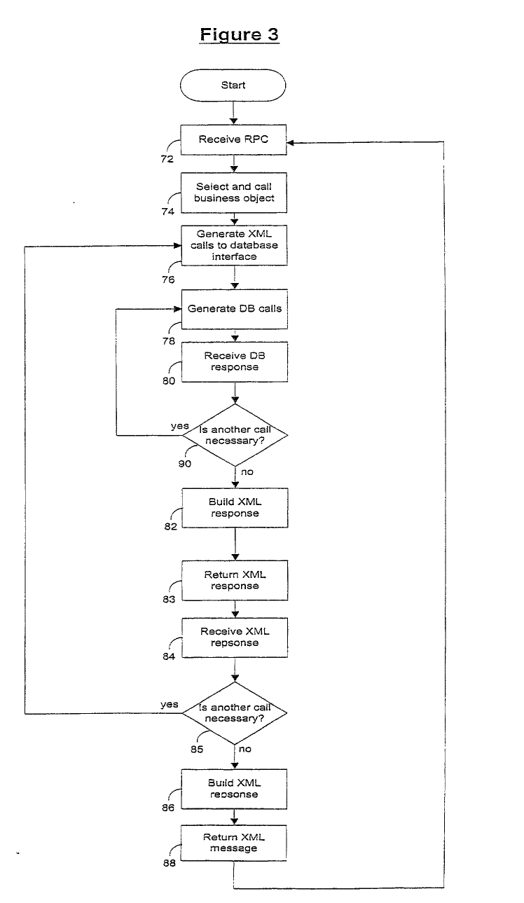

The application server 32 may perform the main processing of the business functions carried out by the ASP 18. The application server 32 may operate within a hardware and software environment. The software environment may comprise a plurality of applications that may be object-oriented and/or table-driven, whereby new products, applications, modules and/or transaction types may easily be integrated. Such software components may include, e.g., an operating environment 41 (e.g. Microsoft Windows NT™, Windows 2000™, or Sun Solaris™), transaction processing software (e.g. Microsoft Transaction Server™), communications software, database tools (e.g. RogueWave™), query and/or reporting software (e.g. Seagate's Crystal Reports™), a database interface 33, a message parser/builder 51, a business function selection object 38, one or more business objects 37, and/or one or more other applications, which may be table-driven. As described hereinbelow with respect to FIG. 3, the message parser/builder 51 may verify access levels of clients accessing the web servers 30, as well as verify the format of XML messages and build appropriate messages to pass to the appropriate selection objects 37 for execution.

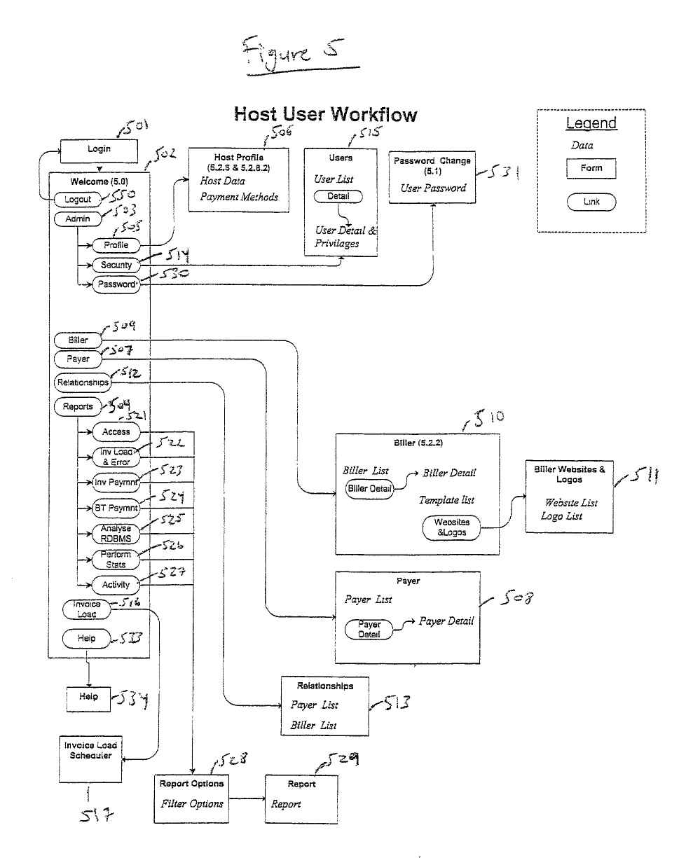

The transaction processing software may be a component-based transaction processing application for developing, deploying, and managing high performance, scalable, and robust enterprise, Internet, and intranet server applications, which defines an application programming model for developing distributed, component-based applications and provides a run-time infrastructure for deploying and managing these applications. A clustering application may optionally be provided for load balancing and fail-over services to cluster distributed application servers into a single, high-performance, highly available environment of application server resources, thereby avoiding bandwidth, latency, and congestion problems and providing multi-server scalability for unlimited concurrent user access. The query and/or reporting software may be an application or object providing for an environment in which client reports and file download formats are easily customizable. One or more business objects 37 or applications may reside on the application server 32, such business objects 37 or applications being the components that perform the central transactional functions of the server 32. The business objects may receive XML messages in a predefined format and return XML response messages in a predefined format. Menus of options (as shown in FIGS. 5-11 and described hereinbelow) may be made available to the client by the message parser/builder 51 (or, as those skilled in the art will recognize, by one of any number of components of the invention, e.g., selector or another business object).

As discussed hereinbelow, exemplary business objects may include an object for reviewing invoices, an object for making adjustments to invoices, and an object for initiating invoice payment. One or more of any of the foregoing described applications may access the database server 36 via the database interface 33 and/or database application 35 for purposes of retrieving and modifying its data. Other applications may be provided, consistent with the provision of billing, payment, or other financial or non-financial services. For example, an e-mail notice application may be provided for sending e-mail notices of the invoices to one or more payer systems 14 which are set up to receive e-mail notices. While the foregoing components of the application server 32 may be referred to herein as “applications”, “modules”, “components”, “interfaces”, and/or “objects”, it should be understood by those skilled in the art that such labels should not be construed in any way to be limitations. Any of the components of the application server 32 may comprise machine-readable programming code embodied in a tangible medium, e.g., Java beans. Depending on whether the embodiment of the invention is object-oriented, such components may or may not be formal objects. A table at the end of this Detailed Description lists exemplary objects and corresponding XML messages in one embodiment of the invention. It is noted that the business objects of the present invention should be modular, i.e., functionality may be added to, deleted from, or modified in the system by adding or removing business objects. Thus, each business object should be constructed with expected input and output data only, as though it were a “black box”. The internal processes of each business object “black box” are not relevant to the overall operation or maintenance of the system, to the extent that any business object with a given set of expected input and output data may be substituted for an existing business object for performing a similar or identical function having the same set of expected input and output data, wherein the system need not ever require knowledge of the internal operation of the business object for proper functioning or maintenance.

With reference to the flowchart of FIG. 3, which illustrates an exemplary operation of the application server 32 in one embodiment of the invention, in conjunction with FIG. 1, the general operation of the application server 32 will now be described. First, an XML remote processing call may be received at step 72 from one of the web servers 30. The message parser/builder 51 may receive from the web servers 30 either an XML message from the software client or an HTTP post from the workstation client. If an XML message is received from a software client, the message parser/builder 51 may verify that the particular client has appropriate access levels for sending such XML message, thereby preventing a person from manually writing an XML message for an option that is outside of the permitted workflow for the client. After verifying access levels, the message parser/builder 51 may verify that the XML message is the exact format needed for passing to the selection object 37. If not, data may be extracted and the appropriate message is built. The message may then be passed to the selection object 37, which may pass the message to the appropriate business object 37 for execution. In the case of an HTTP post from a workstation, the message parser/builder 51 may build an XML message for performing the transaction based on the post and the access levels. The message may then be passed to the selection object 37, which may pass the message to the appropriate business object 37 for execution.

A business function selection object 38 may then make a call at step 74 to the appropriate business object 37 associated with the XML call. The selected business function object may execute and generate at step 76 XML calls to the database interface 33. The database interface 33, in turn, may utilize predefined instructions at step 78 for directing the database server 36 to access and/or write data into the database tables. In one embodiment, the predefined instructions may be a group of instructions, e.g., SQL calls. It is noted, however, that the business function objects 37 may not directly perform the SQL calls at step 78. The database interface 33 object may exist so that the relational structure of the database 36 may be modified without modifying each of the business function objects 37. Each database relational structure may merely need to be defined in a database structure file (not shown) that may be used by the database interface 33 object to structure the appropriate SQL calls for execution at step 78. A response to the SQL call may then be received at step 80 from the database 36. A single XML call at step 76 from a business function object 37 may cause the database interface 33 object to initiate several SQL calls at step 78. Therefore, if more than one SQL call is necessary (as determined at step 90), a plurality of such calls may be initiated at step 78, as necessary, and the corresponding responses may be received at step 80. Once the database interface 33 object has completed the SQL calls at step 78, it may build (at step 82) and return (at step 83) a response XML message to the business function object 37. The response XML message may then be received at step 84 by the business function object 37. A business function object 37 may need to initiate several XML calls to the database interface 33 object during performance of the selected business function, at step 76. Therefore, if more than one XML call is necessary (as determined at step 85), a plurality of such calls may be initiated at step 76, as necessary, and the corresponding database calls may be generated (at step 78) and may be received (at step 80), and appropriate XML responses may be built (at step 82), returned (at step 83), and received (at step 84). Once the XML calls to the database interface have been completed at step 76, (i.e. the business function has been completed), the business function object 37 may build a response XML message at step 86 and may return the XML response message to the web server 30 at step 88, and the foregoing steps repeated for a subsequent XML remote processing call which may be received at step 72.

### Invoice Loader

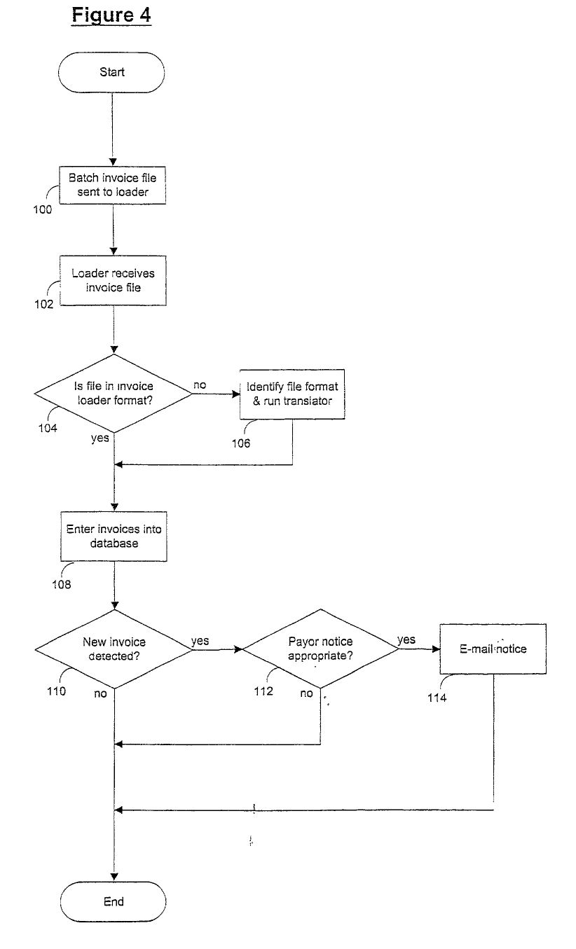

With reference to the flowchart of FIG. 4, which illustrates an exemplary invoice loading operation in one embodiment of the invention, in conjunction with FIG. 1, the general invoice loader 34 operation will now be described. The invoice loader 34 module may provide batch input to the database 36. This may be useful because many enterprise accounting systems may export an invoice file on a periodic basis. The batch invoice file may then be sent at step 100 to the invoice loader module 34 via one of any number of means 53, e.g., as an e-mail attachment, FTP load, an EDI VAN (value added network), or another private network link. Therefore, the invoice loader module 34 may include a network interface (not shown) for coupling to the Internet and may include one or more private network interfaces (not shown) for coupling to EDI VAN's or other private network interfaces. Each of these network interfaces may be a network card, or may comprise such other hardware and software as may be appropriate to effect the network interconnection. Alternatively, the invoice loader module 34 may couple only to a local area network 28 at the processing facility (i.e. at the geographic location of the ASP 18), and one or more routers 24, 26 in the DMZ 22 may serve to couple the invoice loader 34 to the Internet 20 and to each private network, as may be appropriate.

Once the invoice loader module 34 receives the invoice file at step 102, it may verify that the file is in the appropriate invoice loader format at step 104. Typically, the biller may be responsible for running the necessary translation program to convert the invoice file from the biller's accounting system to the invoice loader format. However, it may be possible for the file to arrive at the invoice loader module in the accounting system format, in which case the invoice loader module may then identify the accounting system format and run an appropriate translation program at step 106 to convert to invoice loader format. Exemplary formats from which invoices may be loaded include ANSI X12 810, flat ASCII files, or well formed XML schemas.

Once the invoice file is in the invoice loader format, the invoice loader module 34 may enter the invoices into the database 36 at step 108 and may, if appropriate, send out e-mail notices at step 114 to one or more payer system 14 users indicating that an invoice is available. To this end, the invoice loader module 34 may therefore include an invoice loader application 39. The invoice loader application 39 may make appropriate calls to a database application 35 for loading the invoices. More specifically, the database application 35, which may run on the database server 36 (or, alternatively, on the application server 32), may provide for the raw data stored on the magnetic media to be logically accessible in a relational database table format. Predefined instructions for accessing and writing data into the tables may be sent to the database application 35. In one embodiment, the predefined instructions may be a group of instructions, e.g., SQL calls. The invoice loader application 39 may therefore execute appropriate SQL calls for writing the invoice data to the database 36.

Once the invoice data is in the database 36, e-mail notices of the invoices may be sent out to one or more payer system 14 users who are set up to receive e-mail notices at step 114. An e-mail notice application 31 may be provided on the application server 32 for making appropriate SQL calls to the database 36. Such calls may be made for purposes of detecting new invoices at step 110, as well as determining, based on the identity of the payer, if an e-mail notice is required, at step 112. More specifically, the e-mail notice application 31 may search the database 36 for a flag or other identifier of a new invoice, and then, for each new invoice, may obtain data from a payer's profile indicating whether an e-mail notice is appropriate, and if appropriate, the address to which the e-mail notice should be sent. The e-mail notice application 31 may then send the e-mail. Alternatively, the e-mail notice application 31 may run on the invoice loader module 39 instead of running on the application server 32.

### Database Server

The database server 36 may be an OLTP (on-line transaction processing) system, embodied in a server, such as Microsoft SQL Server 7™, Oracle 8™, Sybase Adaptive Server R12™, DB2™, Informix™, or another ODBC-compliant database. The database server 36 may be configurable for sharing with other applications, including access by a report writer application, and may comprise a distribution and replication protocol (DRP) device. A backup database server (not shown) may also be provided, wherein some or all of the data on the database server may be mirrored to the backup database server. In this configuration, in the event an application performing a transaction on the database server experiences failure, the application may start at the backup server location and proceed from the point of failure, thereby preserving transaction integrity.

The database 36 may be a relational database, i.e., data management technology modeled such that all data is organized as though it is formatted into tables, with the table columns representing the table's fields or domains and the table rows representing the values of the table's fields or domains. Data between tables may be related to one another, using, for example, pointer data. Data may be logically organized as tables but not necessarily physically stored as such. The database interface 33 may access and update data via a language interface or “structured query language” (SQL) calls. The database 36 may comprise a relational database where the payer and biller profiles (which may include access control data and/or dispute rules) may be related between payer systems 14 and biller systems 12. The message parser/builder 51 may retrieve access control data from the database 36 when a workstation client logs on. Similarly, business service provider profiles may be stored in the database 36 and may include access control data for one or more business service providers 16.

Invoice data stored on the database 36 may include invoice-specific data received from the biller 12 each time the biller 12 sends an invoice to the ASP 18. Such data may include, e.g., the identity of the biller and payer, invoice line items, and settlement and payment options. Biller profile data may be stored on the database 36 and may include items that a biller 12 need only enter once, and may change only periodically thereafter. Such items may include dispute rules and access levels for each biller workstation with system access. The dispute rules may be payer-specific or may be may applied globally to all payers.

Payer profile data may be stored on the database 36 and may include items that a payer 14 need only enter once, and may change only periodically thereafter. Such items may include access levels for each payer logon ID (referred to as a payer workstation) with system access.

### Client Types

In one embodiment, two client types may access the ASP 18, a workstation client (e.g. a browser) interfacing with the system 18 utilizing HTML documents and HTTP posts, and a software client interfacing with the system 18 utilizing XML messages. Both billers and payers may comprise workstation clients, and the message parser/builder 51 may present different work flow options to each via menus. Host (or “administrator”) users and help desk users may be biller or payer workstations having access levels which are a subset of all access options available to the biller or payer. Host users (who may be affiliated with a business service provider system) may control most non-invoice related data and functionality. A biller system user may control invoice related data and functionality associated with a specific billing company. A payer system user may have specific functionality associated with all related invoice transactions to the paying company. Help desk users may be provided access to the system in order to troubleshoot users' questions.

Host users (also referred to herein as “administrators”) may configure and maintain the system. A single SuperUser account may be established for each installation of the system. The SuperUser may be pre-configured with the system and have all permissions allowed. The SuperUser may create additional host users with a subset of their permissions. Host users may act as system administrator, whose role is to manage users in the system, handle database administration, monitor system activity, manage enrollment and handle system error conditions.

A host user may create a biller system and one or more biller administrator users associated with such biller system. This action may bind the specific biller system user to the invoices associated with the biller. Additional biller system users may be created by the biller administrator.

Similarly, A host user may create a payer system and one or more payer administrator users associated with such payer system.

A help desk user may be a hybrid type of user. The help desk user may manage technical support issues. This user may log in as any biller or payer system user and use the system as if they were actually that user. The application may disallow any changes made by this user from being committed to the database. The help desk user may be created by a host administrator or SuperUser. A user created as a help desk user may only perform the help desk functionality, with all other system functionality being disabled.

A help desk user may log on to the system through the standard logon page with their own user ID and password. The help desk user may then be immediately presented with the standard logon page, where he or she will then log on with the user ID of the person he or she is helping and the help desk user's password. Upon a successful log on, the help desk user may be connected as if he or she were the actual user, without the ability to modify any data.

### Login and Access

The application server 32 may authenticate each client via a logon process, and each client may have a specific set of access levels for performing certain functions, which may be a subset of all of the functions available to the particular biller, payer or business provider. The message parser/builder 51 may maintain a table of access levels for each client which is currently logged into the system. With respect to transaction requests, when an HTTP post is received from a workstation or an XML message is received from an application client, the message parser/builder 51 may only build the XML message from the HTTP (or pass the XML message received) if the client has appropriate access levels. With respect to responding to a transaction request, the message parser/builder 51 may control the clients' work flow and limit the menu choices which appear in the outbound XML message to those that would be available as next steps in the work flow for the particular client.

The system may permit a user (i.e. the operator of a biller, payer or business service provider workstation) to gain access by clicking on a “login” button on the initial screen, or by going directly to the logon URL without having to navigate through the initial pages by simply entering the full URL in the browser, “bookmarking” the page, or using a “favorites”-type feature of the browser. The system may present the user with a logon page, wherein he or she must specify a valid user ID and password to gain access. If an invalid ID or password is entered, the user may be told that an invalid ID/password was entered. In one embodiment, if a user enters a valid user ID and an invalid password five times in a row, the system may “disable” the user ID (i.e. the system 18 will not present the workstation defined by the ID with other system options until another workstation, with appropriate access levels, performs a function to reset the “disabled” account). If, after this period, the user enters a valid ID and password, the system may display a message indicating that their account has been disabled.

Alternative authentication methods may include any method of verifying the identity of a user or a component of the invention and may include a security mechanism such as one or more of a digital signature, a PIN number, a password, a smart card, or a “master” or “challenge” key. In one embodiment of the invention, an XML script may create a Java applet that monitors the active application and interacts with a separate security server residing within the application server. The Java applet may be configurable to interrupt the current application to prompt for authentication, such as by a digital signature, a PIN number, a password, or a master key, and to communicate with the security server to effect the authentication. If the security operation is successful, the application may continue without interruption; otherwise, the application may be terminated according to the XML script. Alternatively, the foregoing process or a part thereof may be used for transferring data between any two components in an embodiment of the present invention, including those external to the invention, such as an end user, a client, a financial institution, a back office, an administrator, an e-mail or fax recipient, or a server. One or more of the foregoing security operations may be implemented using application security middleware, such as Ubizen's MultiSecure™ ETS, MultiSecure™ ASE, or MultiSecure™ WAC. Further security means may comprise one or more of the following: password or PIN number protection, use of a semiconductor, magnetic or other physical key device, biometric methods (including fingerprint, nailbed, palm, iris, or retina scanning, handwriting analysis, handprint recognition, voice recognition, or facial imaging), or other log-on security measures known in the art. Password protection may include certain validity requirements upon establishing a password, e.g., disallowing more than two consecutive characters in a password, disallowing the same password for a minimum of six consecutive password changes, and/or disallowing more than one user-initiated password change per day. Passwords may be set to expire after a certain number of days, and an inactive user account may be set to expire or become disabled after a certain number of days of nonuse.

Following logon, as described above, a user may be presented with predetermined work flow options based on the access levels available for his or her particular workstation.

### Security

Point-to-point data communications over the Internet may be handled by secure sockets between the web server 30 and client 12, 14, 16. Exemplary protocols used may include Netscape's Secure Socket Layer (SSL) or secure HTTP. As those skilled in the art will recognize, other embodiments of the invention may include one of any number of methods for two-way data encryption and/or digital certification for data being input to and output from the web server 30, to provide security to data during transfer. In particular, an algorithm such as Triple DES may be used to encrypt such data as account numbers, credit card numbers, tax ID numbers and/or passwords.

### Host User Workflow

FIG. 5 illustrates an exemplary host user workflow in one embodiment of the system. When a user logs in 501 to the system using the user ID of a host user, the system may display a host administration or “welcome” page 502. The system may display the user's name at the top in the form of a “Welcome ‘Username’” message, for personalization. The system may display a host administration page containing host statistics and a list of “action items” with current counts and links to the corresponding pages. Such counts may include biller count, payer count, enrollment request count, connected user count, invoice load error count, total invoice count, and paid invoice count. The system may calculate these reported statistics at the time the active user logs on to the system and/or may update these statistics in real time. As part of reporting these statistics, a query tool may be integrated into the system to generate pre-formatted reports. The system may permit the host user to return to this page by clicking on a link that may be present on every page during system access. One area of the screen may contain navigation buttons grouped into categories, e.g., administration 503 and reports 504. The system may permit these categories to be expanded into subcategories that modify another portion of the screen. One area of the navigation frame may contain the user name (not the user ID) who is logged on. The system may permit clicking on this link to modify the user's basic profile information, which the system may store as global information on the database.

The system may permit a host user to select an option to edit payers 507, wherein the system may permit the administrator to add, modify, or delete payers from an edit payer page 508. A payer may be a company that does business with one or more billers in the system. Each payer system may have one or more users that will have certain permissions. The edit payer page 508 may contain a list of current payers in the payers list box. When an administrator selects a payer, the system may display information for that payer in the company information section. The system may permit an administrator to add information for a new payer in the company information section and select “add” to add the new payer. The system may permit company data to be entered for the following exemplary fields, which the system may store as global information on the database: name, “division”, address, city, state, zip, country, SIC code, TIN, and organization type. The system may require the company name plus “division” to be unique. The system may permit modify and delete operations to be performed on the currently selected payer. The system may require fields for company information, such as name and phone. The system may display the list of payers and permit search and find operations, next and previous page navigation, first letter selector navigation, and scrolling navigation, in order to effectively display large numbers of payers.

The system may provide a user list box, which may be populated with the selected payer system's user names. As the administrator clicks on each user in the list, the system may display the user's information in the user information section. The system may provide an “edit users” option for directing the administrator to an “edit users” page, if the payer has been saved to the database. The system may provide an “edit users” page to allow the administrator to add, modify, or delete users associated with the current payer. This page may display the name of the payer at the top. The system may permit the host user to select an option to edit the active user profile 505, wherein the system may direct the host user to a page 506 displaying the organization name of the host, biller or payer at the top, to establish the context of the current edit. The system may permit information to be maintained and edited at this page, which the system may store as global information on the database, including, e.g., last name, first, middle, phone, fax, e-mail, e-mail2, user id, password, confirmation, language, currency and privilege group. The system may require certain fields for user information, such as last name, first name, e-mail and phone. The system may provide a reset password button to reset the selected user's password to the default setting (e.g. user's last name). The system may also permit the administrator to add a new user to the current payer by entering information into the user information section and selecting “add”. The system may require the combination of last name, middle initial and first name to be unique. The system may permit modify and delete operations to be performed on the currently selected user. The system may provide a checkbox for temporarily deactivating a user. The system may automatically send an e-mail to a new user after they have been added, informing them of how to connect and logon to the system. The system may not permit a host user to set permissions. The system may permit a host user to create biller or payer system administrator users, both of whom may be afforded all permissions.

The system may permit the host user to select an option to edit billers 509, wherein the system may permit the administrator to add, modify, or delete billers from an edit biller page 510. A biller may be a company that does business with one or more payers in the system. Each biller system may have one or more users that will have certain permissions. The edit biller page 510 may contain a list of current billers in the biller list box. When an administrator selects a biller, the system may display the information for that biller in the company information section. The system may permit the administrator to add information for a new biller in the company information section and select “add” to add the new biller. The system may permit company data to be entered for the following exemplary fields, which the system may store as global information on the database: name, address, city, state, zip, country, SIC code, TIN, and default template type. The system may require that the company name be unique. The system may permit modify and delete operations to be performed on the currently selected biller. The system may require certain fields for company information, such as name and phone.

The system may permit a host user to select an option to edit biller websites and logos, directing the user to a biller website and logo page 511. The system may display a list of billers, and upon selection of a biller from the list, the system may populate the company information area with details about the current biller. For each biller, the system may permit a list of company logos and websites to be edited. The system may make new logos available to the system with an “add” button which uploads the logo file, and may likewise permit logos to be removed from the system with a “remove” button. The system may display a list of websites via a listbox containing the sites and a site details edit area. Upon selection of a website in the list, the system may populate the site details section. The system may permit the URL, description, and type of website to be edited. The system may provide a delete button for removing a site from the list. The system may provide a save button to save the current website. The system may provide a new site button for emptying the edit area to allow a new site to be entered and saved. The system may provide selectable links for accessing the biller's enrollment page and biller profile page. The system may be adapted to store logo and website data as global information on the database.

As described above with respect to users associated with payers, the system may provide a user list box, which the system may populate with the selected biller system's user names, and the system may provide an “edit users” option for directing the user to an “edit users” page, where the system may allow the administrator to add, modify, or delete users associated with the current biller.

The system may permit the administrator to add a new user to the current biller by entering information into the user information section. The system may require that the combination of last name, middle initial and first name be unique. The system may permit modify and delete operations to be performed on the currently selected user. The system may provide a checkbox for temporarily deactivating a user. The system may be adapted to store contact information as global information on the database, including, e.g., last name, first, middle, phone, fax, e-mail, e-mail2, user ID, password, confirmation, language, currency and privilege group. The system may require certain fields for user information, including last name, first name, e-mail and phone. The system may provide a reset password button for resetting the selected user's password to the default setting. The system may be adapted to automatically send an e-mail to a new user after they have been added, telling the user that they have 24 hours to log in and change their password or the account will be disabled (e.g. where the password is set to the default of user's last name; accounts may be re-enabled by a host user). The e-mail may inform them of how to connect and logon to the system.

The system may permit a host user to select a “relationships” option 512 for being redirected to a relationships page 513 for viewing, modifying and/or establishing biller/payer relationships. This page may contain a list of current billers in the billers list box and two payer list boxes: available payer and related payer. When a user selects a biller from the list box, the system may update the two payer list boxes. The available payer list box may contain all payers not currently related to the selected biller that have been approved by the biller. The related payer list box may contain all payers currently related to the selected biller. The system may provide “add” and “remove” buttons to allow payers to be added or removed from the related payers list. The system may display in a Payer ID# field the system-wide biller-customer number for the selected payer from either list. The system may not save this page unless all related payers have Payer ID#'s and may display a warning message may inform the user of this condition. The system may be adapted to store payer/biller relationship data as global information on the database.

The system may permit the host user to select an option to add/modify/delete administrators associated with the host. The system may permit the administrator to add a new user to the channel host by entering information into a user information section and selecting “add”. The system may require that the combination of last name, middle initial and first name be unique. The system may permit modify and delete operations to be performed on the currently selected user. The system may provide a checkbox for temporarily deactivating a user. The system may be adapted to store contact information as global information on the database, including, e.g., last name, first, middle, phone, fax, e-mail, e-mail2, user ID, password, confirmation, language and privilege group. The system may require certain fields for user information, such as last name, first name, e-mail and phone. The system may provide a reset password button for resetting the selected user's password to the default setting. The system may be adapted to automatically send an e-mail to a new user after they have been added, informing them of how to connect and logon to the system.

The system may permit a host user to select an option 514 to change security information, in which case the system may permit administrator, biller and payer security settings to be modified at one or more user security/privilege pages 515. In the various privilege pages, the system may permit the privilege group to be entered and presented in the local language. The system may present the list of functional access permissions in the language of the active user. For changing privilege information relating to host administrators, the system may permit administrator privilege groups to be defined and edited. The system may display a list of available permissions, the permissions being inherited from the active user currently logged on. The system may provide a listbox containing all defined administrator privilege groups, wherein selecting a previously defined group may cause the system to populate the list with the corresponding settings. The system may provide an “all” button for setting all permissions when selected, and a “none” button for clearing all permissions when selected. The system may permit add, modify and delete operations to be performed on the current privilege group. The following list may be representative of exemplary permissions that may be set for host administrators: create new billing entities; create/maintain new biller system administrators; activate new biller system administrators; create new paying entities; create/maintain new payer system administrators; activate new payer system administrators; create/maintain new host administrators; maintain biller-payer relationships; reset biller/payer system administrator user passwords; maintain adjustment codes; edit mailing lists; and run canned reports.

For changing privilege information relating to billers, the system may permit biller permissions to be defined and edited. The system may display a list of available permissions, the permissions being inherited from the active user currently logged on. The system may provide a listbox containing all defined biller privilege groups, wherein selecting a previously defined group may cause the system to populate the list with the corresponding settings. The system may provide an “all” button for setting all permissions when selected, and a “none” button for clearing all permissions when selected. The system may permit add, modify and delete operations to be performed on the current privilege group. The following list may be representative of exemplary permissions that may be set: create/maintain new biller system users; activate biller system users; create/maintain new biller system administrator users; reset user passwords; maintain adjustment codes; edit biller bank holidays; edit biller/payer agreements; edit mailing lists; and run canned reports.

For changing privilege information relating to payer system users, the system may permit payer permissions to be defined and edited. A list of available permissions may be displayed, the permissions being inherited from the active user currently logged on. The system may display a listbox containing all defined payer privilege groups, wherein selecting a previously defined group may cause the system to populate the list with the corresponding settings. The system may provide an “all” button for setting all permissions when selected, and a “none” button for clearing all permissions when selected. The system may permit add, modify and delete operations to be performed on the current privilege group. The following list may be representative of exemplary permissions that may be set: create/maintain new payer system users; activate new payer system users; create/maintain new payer system administrators; reset user passwords; maintain adjustment codes; edit payer bank holidays; edit biller/payer agreements; edit mailing lists; and run canned reports. The system may be adapted to store any of the foregoing permission data as global information on the database.

The system may permit a host user to select a “load invoices” option 516 for being redirected to a page 517 for performing a manual load of selected invoice files or controlling the automatic loading times of biller uploads. The load invoice page 517 may contain a list of current billers in a billers list box. When an administrator selects a biller, the system may use files found in the directory or subdirectories used for invoice loading associated with the selected biller to populate the invoice files list box. The system may permit the host user to select one or more files from the invoice files list box and select an option for loading them at that time, which may force the system to load the selected invoice files immediately. After the process is complete, the system may display any error information that occurred during processing may on this page. The system may handle the automatic loading of invoices through a scheduling interface.

The system may permit a host user to select a “host profile” option 505, which may direct the user to a host profile page 506 for allowing the host's profile information and payment method information to be edited. The system may allow data to be entered for the following exemplary fields, which the system may be adapted to store as global information on the database: name, address, city, state, zip, country, phone, number, fax number, and maximum invoice amount allowed. The system may use the maximum invoice amount allowed field to establish a threshold for a maximum payment for a single invoice. The system may permit invoice values that exceed this amount to be loaded into the system but not to be paid through the system. The system may also permit payment method information to be modified at this page, i.e. the system may permit the administrator to define the payment methods that the host has currently enabled. The system may display a payment methods area consisting of two listboxes, an available methods box containing all the payment methods that are currently unassigned by the host, and an enabled methods box containing all the methods the host has enabled. The system may provide two buttons to allow methods to be transferred from box to box. The system may provide save and cancel buttons at the payment methods area. Exemplary available payment methods may include ACH debit, credit card/procurement card, and paper check.

The system may permit the host user to select a reports option 504, which may cause the system to display subcategories that correspond to the available reports. Exemplary reports the system may generate may include: access report 521; invoice load and error reports 522; invoice payment reports 523; bottomline payment reports 524; analyze RDBMS (Relational Database Management System) 525; review performance statistics 526; and activity report 527. Activity report 527 may cause the system to detail the following exemplary activities: create new biller/payer; create new contacts; add/remove biller-payer relationships; edit biller bank holidays; edit biller/payer profiles; reset biller/payer system administrator passwords; add/edit adjustment codes; edit mailing lists; edit contact info; create new logins for contacts; edit login info; disable/enable logins; and help desk login. The system may permit the user to select from among various reporting options and/or filters 528 (which the system may be adapted to store as global information on the database), and the system may then generate a report and permit the user to view and/or print it at a report page 529.

Other functionality which the system may provide for the host user includes a password change selection 530, which may cause the system to direct the user to a password change routine 531; a help selection 533, which may cause the system to direct the user to a help routine 534; and a logout routine 550.

### Biller System Workflow

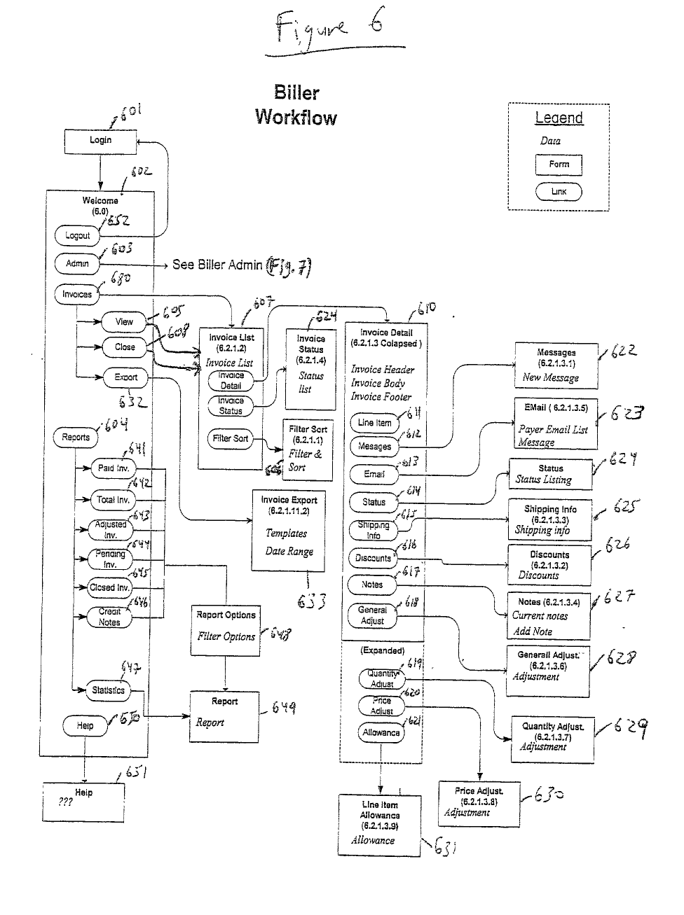

FIG. 6 illustrates an exemplary biller system workflow in one embodiment of the system. When a user logs in 601 to the system using the user ID of a biller, the system may display a biller system administration or “welcome” page 602. The system may display the user's name at the top in the form of a “Welcome ‘Usemame’” message, for personalization. The system may display at a biller system administration page key biller statistics and a list of “action items” with current counts, amounts in local currency and links to the corresponding pages, as well as information about the basic functionality of the main topics. The system may also display at this page information provided by the administrative user regarding how to contact the administrative user. The current counts may include total invoices, closed invoices, paid invoices, unpaid invoices, and adjusted invoices. The system may provide a selection to the user for filtering and/or sorting the counts. The system may permit the biller system user to return to this page by clicking on a link that may be present on every page during system access. One area of the screen may contain navigation buttons grouped into categories, e.g., administration 603 (discussed further hereinbelow at “Biller System Administration”), invoices/payments 680, and reports 604. The system may expand these categories into subcategories that modify another portion of the screen. One area of the navigation frame may contain the user name (not the user ID) who is logged on. The system may allow the user to click on this link to modify his or her basic profile information. The system may provide other functionality, including a “help” button 650 for directing the user to a help section 651 and a “logout” button 652 for logging the current user out of the system.

The system may allow the biller system user to select an option to edit the active user profile, wherein the system may direct the biller system user to a page displaying the organization name of the biller at the top, to establish the context of the current edit. The system may permit information to be maintained and edited at this page and may store the information as global information on the database, e.g., last name, first, middle, phone, fax, e-mail, e-mail2, password and confirmation. The system may require certain fields for user information, including last name, first name, e-mail and phone. The system may include this information in e-mails which may be sent through the system and may also make this information available to biller and payer system administrators.

The system may permit a biller system user to select an option 605 to display invoices based on selected criteria and/or specify general search criteria for listing invoices. Depending on the selection, the system may direct the user to a “view options” page 606 for filtering and sorting. The system may provide a view options page 606 to allow the user control over the subset of data that will be displayed and the order in which the data will be presented. To further facilitate the presentation of invoices, the system may permit settings associated with a specific report to be automatically saved and used again the next time the user generates the report. Considering the time it may take to generate certain reports (e.g. lengthy reports), the system may also provide an option to bring this page up before running a report, to limit the scope and time. The view options page may consist of three exemplary areas: filter, sort and options. In the filter area, the system may provide the following exemplary choices: by date (past due, eligible for discount, due within xxx days); and by status (paid invoices, adjusted invoices, unpaid invoices, paid through another source); and by payer (all payer, specific payer); and by attribute range between xxx and yyy (none, invoice numbers, store/location, purchase orders, purchase request number, invoice issue dates, dollar amount, bill of lading numbers, receiving location zipcodes, invoice aging). The system may also provide the ability to search for invoice number, store or location number, routing number and P.O. number, by using wildcards. The system may provide a sort area to allow returned results to be sorted in ascending or descending order according to the following exemplary criteria: due date, invoice number, invoice date, purchase order number, net amount due, store or location number, and invoice aging. In one embodiment, the system may allow sorting criteria and order to be determined by a sort order combo box, which may default to ascending, and three sort criteria boxes, the first of which defaults to due date, while the rest default to no sort criteria (spaces). The system may provide an options area with the following exemplary choices: display all in one page or show count (with the default being all in one page), remember and use previous settings, and show view options page before presentation. The system may be adapted to store filter, sort, and options data as global information on the database.

The system may allow a biller system user to select an option to display a page 607 for listing invoices matching specified criteria. The system may display at this screen the filter/sort criteria that are in use for this display. The system may display invoices using a paging concept (i.e. 1-20 of 362). When displaying invoices, the system may remove any existing navigation area, so as to optimize the invoice display area. In one embodiment, the system may display a page separated into two sections, with the header section containing non-scrolling data and/or buttons and the body section that scrolls as necessary, depending upon the width of the browser window and the number of invoices being displayed. The header section may contain the following elements:

The user's selection criteria, i.e., All Invoices—Past due.

The display range text in the format of first—last of maximum, i.e., 1-20 of 200.

“Next ‘n’” may cause the system to navigate the user to the next “n” invoices, i.e., “Next 20”. If the last “n” invoices are currently being displayed the system may disable the “Next” button.

“Previous ‘n’” may cause the system to navigate the user to the previous “n” invoices, i.e., “Previous 20”. If the first “n” invoices are currently being displayed the system may disable the “Previous” button.

“All” may cause the system to change the mode from displaying a page of invoices to displaying all invoices, and the system may label the button “Page”, i.e., 1-200 of 200. If the “age” button is selected, the system may display at this page the first “n” invoices, and system may label the button “All”.

“Back” may cause the system to return to the previous screen, step, or function.

“Search” may cause the system to perform a search in the current invoice list by using the “Find” feature. The system may permit only the invoices currently being displayed to be searched. The system may allow the user to type a string to search for before selecting the “Search” button. The system may search each invoice may for the specified string. If a match is found, the system may scroll the invoice record into view and select the text found. Selecting “Search” again may cause the system to find the next instance of the string. The system may permit wildcard searches.

“Show Selected” may cause the system to display all invoices that have been manually checked. In the last column of the invoice list, the system may allow a user to select individual invoices. While the user remains on this page, the system may maintain in a list all invoices that are marked as selected. If the user switches the context of this view, the system may not remove any selection made by the user. Clicking on the “Show Selected” button may cause the system to display all the invoices the user has selected. The system may change this button to either “Page” or “All”, depending on the state of the selection when this button was pressed. Selecting this button again may cause the system to return the invoice list to its previous mode. The system may display all selected invoices, even if they exceed the page limit.

“Close” 608 may cause the system to mark as closed all invoices that are selected. The system may display to the user a confirmation message before the invoices are closed, e.g., “You have selected 24 invoices to close. Are you sure you want to close these invoices?” The system may not permit closed invoices to appear in any active queries. The system may subject invoices that are marked as closed to host archiving and purging criteria.

“Paid Through Another Source” may be provided by the system as an option for the biller system user to mark an invoice as closed by selecting desired invoices and clicking on the “Paid through another source” button. Once this occurs, the system may, for the invoices in question, update their audit trail to reflect that they were paid outside the system, and then change their status to “Closed”. In the body section, the system may display all invoices in table format. The width of the table columns may be proportional to the width of the browser window. If the browser window is narrowed, the system may decrease column widths appropriately and wrap text within each column, as necessary. If an invoice has adjustments, the system may highlight that line in color to indicate this fact. The system may link the invoice number field to the invoice detail page. The system may link the status field to the invoice history page, at which the system may display a full status history for the selected invoice. By default, the system may display the following exemplary columns: payer name, invoice number, due date, status, net amount due, amount to pay, P.O. number, P.O. requisition number, store number, and select.

The system may permit the biller system user to select an option to display the details of a selected invoice, which may cause the system to direct the user to an invoice detail section 610. The system may use one or more predetermined, customizable and/or selectable template schema (which may be stored as global information on the database) to format the biller detail, and the system may provide a single biller multiple templates from which to select. The invoice detail page may contain various sections. One section may display summary information for the selected invoice, information about the biller, information about the particular invoice, and/or information about the payer. The system may provide selectable buttons for obtaining more information about the current invoice, e.g., items 611, messages 612, e-mail 613, status 614, shipping info 615, discounts 616, and notes 617. The system may display line items that have been adjusted in a different color. Upon selection by a user of the items button 611, the system may toggle the header view from showing a detailed header description to allowing the user to perform basic search operations on the details of this invoice. The items button 611 may cause the system to toggle to header. Clicking on the header button may cause the system to return to the previous view, thereby providing more space for viewing details on the current page, as follows. Another section may contain the line items that make up the invoice. The system may color code highlight line items that have been adjusted. Each line may have a clickable line number. Clicking a line item's number may cause the system to expand the line to show its detail. Clicking a particular adjustment may cause the system to display a window with details about that specific adjustment. Another section may contain the invoice summary. For both the original amount billed and the amount to pay, the system may calculate and display the following: gross total invoice; time conditional discount; other discount/charge; a general adjustments link displays the general adjustment that was entered for this invoice (the system may only present this link if this invoice has a general adjustment; the system may show each general adjustment separately; and the system may permit general adjustments to be removed); sales tax; other tax; and net amount due.

The system may, upon selection of the messages button 612, display a new browser window 622 allowing the biller system user to enter a new message for the payer associated with the current invoice. The system may permit new messages to be entered into a textbox and sent by pressing a “save” button. The system may provide a “cancel” button for discarding the current message and returning to the invoice detail page. The system may provide a discounts button 616 for opening a separate browser window 626 displaying discounts information for the current invoice, including, e.g., time conditional discount %; time conditional discount amount; time conditional discount date; invoice date; and unconditional discount or charge. The system may provide a shipping info button 615, which may cause the system to display additional shipping information for this invoice in a separate browser window 625, including, e.g., ship to location, date shipped, carrier, bill of lading number, terms, units, unit code, weight, volume, package dimensions, package contents, and notes. The system may provide a notes button 617 for opening a separate browser window 627 containing a list of entered notes for this invoice. In the separate browser window, the system may permit the user to enter new notes into a new note textbox and save them by clicking an “add note” button. Clicking a “cancel” button may cause the system to return the user to the invoice detail page, discarding any new notes. The system may automatically log adjustment notes and biller disputes as notes for the current invoice. The system may provide an e-mail button 613 for opening a separate browser window 623 with a new e-mail referencing the selected invoice. The system may permit the user to enter an e-mail message to selected users about the current invoice. The system may permit e-mail to be sent to the recipients that are picked from the recipients list, the contents of which may be based on the e-mail distribution list set up by the payer system administrator. The system may provide a status button 614 for opening a separate browser window 624 displaying a page containing the status history for the selected invoice, including, e.g., date/time, user ID, and user name and status. The system may further provide adjustment buttons, e.g., general adjustment 618, quantity adjustment 619, price adjustment 620, and allowance 621, at the invoice detail 610 section. The system may permit a general adjustment button 618 to be selected to open a separate browser window 628 containing general adjustment information for this invoice. This information may be read-only and may include the following exemplary items of information: adjustment amount, reason code, and notes. The system may permit a quantity adjustment button 619 to be selected for a specific invoice line item to open a separate browser window 629 containing quantity adjustment information for that line item. This information may be read only and may include the following exemplary items of information: adjustment quantity, reason code, and notes. The system may permit a price adjustment button 620 to be selected for a specific invoice line item to open a separate browser window containing price adjustment information for that line item. This information may be read only and may include the following exemplary items of information: new price, reason code, and notes. The system may permit an allowance button 621 to be selected for a specific invoice line item to open a separate browser window 631 containing allowance information for that line item. This information may be read only and may include the following exemplary items of information: allowance amount, reason code, and notes.

The system may make other options available to the biller system user for selection, e.g. an items button for displaying the invoice details in item view. The system may, upon selection of such an button, remove the header from the invoice details and all but the net amount due field of the footer, thereby allowing more screen space to be used for the presentation of invoices. The system may provide a search function for performing a search in the current invoice list. The system may permit only the invoices currently being displayed to be searched. The system may allow the user to type a string to search for before selecting the “Search” button. The system may search each invoice may for the specified string. If a match is found, the system may scroll the invoice record into view and select the text found. Selecting “Search” again may cause the system to find the next instance of the string. The system may permit wildcard searches. The system may provide clickable line numbers in the items view line, whereby upon clicking a line item's number, the system may expand the line to show its invoices, and clicking a particular adjustment may cause the system to bring up a window with details about that specific adjustment.

The system may permit the biller system user to select an option 608 to retrieve all closed invoices in the system subject to the criteria set in the view options page and may provide the additional option of restoring selected invoices that have been closed into the current collection. The system may move invoices that have been checked to the open state when the user selects an “open” button.

The system may permit the biller system user to select an option 632 to export files, i.e. to download data directly from the server, bypassing the need to have the data flow through a transmission to the biller system user. Selecting the export files option 632 may cause the system to direct the user to the invoice export section 633, from which the user may either edit export templates or export files. Upon selection of edit export templates, the system may allow the biller system user to edit the templates used in file export. An export templates listbox may show the present export templates while a template settings area may contain all the attributes and settings of the current selected template. Upon selection of a template from the export templates listbox, the system may populate the fields of the template settings area. In this area, the system may allow the biller system user to add, modify, or delete file export templates by using a set of buttons or controls. The set of invoices to be exported may be based on the invoices that are being viewed at the time export is chosen. The system may permit the user to set that filter through the filter/sort page. The template settings area may contain the following exemplary controls (which the system may be adapted to store as global information on the database): fields and export order (may contain a listbox of the available invoice fields and an ordered listbox of fields marked for export with two buttons for moving fields between listboxes; up and down buttons may allow the field export order to be changed); and file formats (a listbox that allows the file format to be selected; if ASCII is chosen a delimiter section may be displayed and the user may need to select field and record delimiters). The system may provide a “set default” button for allowing the user to set the current template as the default template for the file export page. Upon selecting file export, the system may allow the biller system user to export invoices based on an export template. In the templates listbox, the system may show the present export templates while the export range may allow the user to select the date range criteria for including invoices in the export. In the templates list, the system may default to the template set as default from the edit export templates page; if no default template was set, the system may select the first entry in the listbox. An “export” button may cause the system to perform the file export, while a “cancel” button may cause the system to abort. The system may be adapted to export files in such exemplary formats as 810 for invoices, 820 for payments, XML, delimited files, and fixed-length PayBase™ compatible files.

The system may permit the biller system user to select a reports option 604, which may cause the system to display subcategories that correspond to the available reports. Exemplary reports may include: paid invoices 641, total invoices 642, adjusted invoices 643, pending invoices 644, closed invoices 645, credit notes 646, and statistics 647. Other exemplary reports may include cashflow forecasting, aged outstanding invoice, returned items, modified invoice history, biller profile maintenance, payment history, and outstanding invoice status. The system may permit the user to select from among various reporting options and/or filters 648 (which the system may be adapted to store as global information on the database), and the system may then generate a report 649 for viewing and/or printing.

### Biller System Administration Workflow

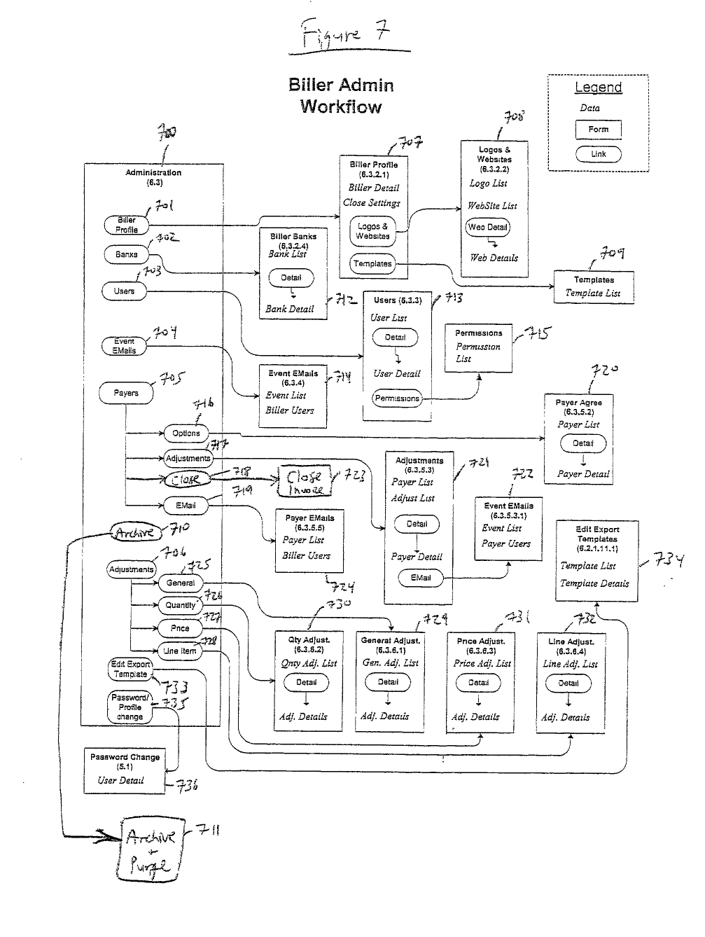

FIG. 7 illustrates an exemplary biller system administration workflow in one embodiment of the system. From the administration 700 screen, the system may permit a biller system administrator to select from among functions including, e.g., edit biller profile 701, archive/purge 710, edit banks 702, edit users 703, edit event e-mails 704, edit payers 705, adjustments 706, edit export template 733, and password/profile change 735.

Upon selection by the biller system administrator of the edit biller profile 701 function, the system may redirect the biller system administrator to a biller profile section 707 for editing the biller's profile information. The system may permit company data to be entered and/or edited for the following exemplary fields (which the system may be adapted to store as global information on the database): name, address, city, state, zip, country, SIC code, TIN, and default template type. From the biller profile section 707, the system may permit the biller system administrator to select a function for editing logos and websites, which may cause the system to direct the administrator to a logo and website editing page 708, wherein the administrator may edit the biller's logos and available websites (which the system may be adapted to store as global information on the database). The system may display a list of billers, and the selection of a biller from the list may cause the system to populate the company information area with details about the current biller. For each biller, the system may permit a list of company logos and websites to be edited. The system may permit new logos to be made available to the system with an “add” button for uploading the logo file, and the system may likewise permit logos to be removed from the system with a “remove” button. The system may display a list of websites via a listbox containing the sites and a site details edit area. Selecting a website in the list may cause the system to populate the site details section. The system may permit the URL, description, and type of website to be edited. The system may provide a delete button for removing a site from the list and a save button for saving the current website. The system may provide a new site button for emptying the edit area to allow a new site to be entered and saved. The system may provide selectable links for accessing the biller's enrollment page and biller profile page. The system may permit the administrator to select a template editing function, which may cause the system to direct the user to a template editing section 709. In the template editing section, the system may permit one or more predetermined, customizable and/or selectable template schema (which the system may be adapted to store as global information on the database) to be established and/or edited to format the biller detail, and the system may provide a single biller multiple templates from which to select.

The system may permit the administrator to select an archive/purge 710 function, wherein the system may direct the administrator to an archive/purge section 711. In this section, the system may permit the administrator to select functions for archiving (which the system may be adapted to store as global information on the database), including archiving data to a separate table, modifying options controlling when archiving is to occur (e.g. if an invoice stays in the “Presented” or “Viewed” state for more than X days; if an invoice stays in the “Paid” state for more than X days; and/or when an invoice is closed, it may be automatically archived); and reporting against archived data. The system may provide purging features (which the system may be adapted to store as global information on the database), including purging records only from the archive table(s); modifying options controlling when to purge (e.g. purge records after X days in archive; or manual purge).

Upon selection by the biller system administrator of the edit banks 702 function, the system may redirect the biller system administrator to a biller bank editing section 712 for allowing the bank information associated with the biller to be edited. It is contemplated that a biller may have multiple banks with each bank having multiple bank accounts. An exemplary edit banks 712 section may be separated into two sections. In the first section, the system may display the following exemplary fields (which the system may be adapted to store as global information on the database): name, address, city, state, zip code, country, country#, account # and RTN. The system may utilize a MOD9 or similar algorithm to verify valid routing numbers. In a second section, the system may display for the selected bank a “holidays” list-box populated with all bank holidays associated with this bank. Selecting an existing bank holiday from this list box may cause the system to delete the entry. Selecting a delete button may cause the system to delete the selected bank holiday. The system may provide combo-boxes for month, day and year selection. Selecting an add button may cause the system to add the selected date to the holiday list-box. If a bank is added with, or is caused to have no holidays through later modification, the system may display a warning to the user.

The system may permit the administrator to select a “users” 703 function, wherein the system may direct the administrator to an edit user section 713. In this section, the system may permit the administrator to add, modify or delete users associated with the current biller. At this page, the system may display the name of the biller at the top to establish the context of the edit. The system may populate a list box with the selected biller system's user names. As the administrator clicks on each user, the system may display the user's information in a user information section. The system may permit the administrator to add a new user to the current biller by entering information into the user information section. The system may require that the combination of last name, middle initial and first name be unique. The system may permit modify and delete operations to be performed on the currently selected user. The system may provide a checkbox for temporarily deactivating a user. The system may maintain contact information (which the system may be adapted to store as global information on the database), including, e.g., last name, first, middle, phone, fax, e-mail, e-mail2, user ID, password, confirmation, language and privilege group. The system may require certain fields for user information, such as last name, first name, e-mail and phone. The system may provide a reset password button for resetting the selected user's password to the default setting. The system may automatically send an e-mail to a new user after they have been added, telling the user how to connect and logon to the system. As described above with reference to the host user modifying privilege information, the system may similarly permit a biller system administrator to access a permissions section 715 for modifying permission/privilege information (which the system may be adapted to store as global information on the database).

Upon selection by the biller system administrator of the event e-mails 704 function, the system may direct the biller system administrator to an event e-mail section 714. In this section, the system may permit biller system users to be associated with specific system events, which associations the system may be adapted to store as global information on the database. Any time one of these specific events occurs, the system may generate an automatic e-mail and send it to the selected list of biller system users. For example, exemplary distribution list choices may include: invoices loaded successfully, invoices loaded unsuccessfully, invoice adjusted, payment authorized, payment canceled, payment completed, and payment notification. The system may display on this page a list-box that contains all biller system users currently in the selected distribution list and a list-box that contains all biller system users currently not in the selected distribution list. In one embodiment, the system may provide two buttons to allow users to be added or removed from the distribution list. The system may permit a default e-mail address to be set up for each event, e.g. the biller system administrator. The system may permit the user to remove this value and/or add to the list. The system may send an automatic e-mail to one or more biller system users when a payment is made. The system may send a summary of the payments made to each biller that has payments in the given payment run. The system may send to designated biller system users an e-mail with the following exemplary information: summary of payments made on today's date, payer name; payer number; total number of payments; and total amount of payments.

The system may further direct the biller system administrator, upon selection of the payers feature 705, to selections for performing tasks including options 716, adjustments 717, close invoices 718 and e-mail 719. Selecting the options 716 task may direct the biller system administrator to a payer options 720 section, where options for a specific payer may be entered and/or edited. The system may display, at the payer options page, a list-box with all the payers related to the biller, with the system pre-selecting the most recently selected payer in this session by default. If no payer has previously been selected, then the system may not pre-select a payer in the list box. For the selected payer, the system may display the following exemplary payer options (which the system may be adapted to store as global information on the database): hide line items from invoice listing; allow payments; include signature; web site selection (which may be displayed using one or more multiple select listboxes); logo selection; payer ID; payment methods and account section (may cause the system to associate payment methods with biller account, and may include a set default button to establish the biller's default method and account); set default payment method and account; marketing message; legal text; and payer model. The system may provide a load default button to fill in all fields with the default entries. The system may provide a save default button to save the current entries as the default settings. Hitting the save button may cause the system to save the current payer's options, while hitting the cancel button may cause the system to discard any changes. Selecting the adjustments task may cause the system to direct the biller system administrator to an adjustments section 721, where the system may permit the administrator to establish adjustments available to a specific payer and establish an e-mail notification list. The system may provide a checkbox for enabling and disabling disputes. If disputes are enabled, the system may make available for selection in a listbox the adjustments that the biller will allow the payer system users to make. The system, through the adjustments listbox, may enable the actual selection of adjustments available to the payer system users. The system may make all adjustments selected be available as long as the enable disputes checkbox is checked. The system may also provide a checkbox for e-mailing one or more biller system users on adjustments. If this option is selected, the system may enable a mailing list button for sending automatic e-mails. The system may send to designated biller system users an e-mail for each adjustment made with the following exemplary information: “the following adjustment was made by payer name on today's date”; payer number; invoice number; adjustment type; adjustment amount; and adjustment reason. If there is no address set up to receive this e-mail, the system may send an e-mail message by default to the biller system administrator. The system may permit a mailing list function 722 may be accessed by the biller system administrator for modifying mailing list settings (which may be stored as global information on the database). The system may provide a close invoice function 718 for directing the biller system administrator to a close invoice section 723 to establish invoice-closing criteria for each payer. The system may only permit invoices with the status of “paid”, “presented”, or “viewed” to be closed. All other invoice states may indicate payer workflow is in progress, and the system may not permit invoices having such states to be closed. At the payer invoice close page 723, the system may display a list-box with all the payers related to the biller, with the system pre-selecting the most recently selected payer in this session by default. If no payer has previously been selected, then the system may not pre-select a payer from the list-box. For the selected payer, the system may present invoice closing criteria. The system may process criteria entered during the next nightly sweep. The system may mark as closed invoices that meet the closing criteria. Selecting the e-mail 719 task may cause the system to direct the biller system administrator to a payer e-mail 724 section for associating a list of biller system users with a specific payer (which associations the system may be adapted to store as global information on the database). At the payer e-mail page 724, the system may display a list-box with all the payers related to the biller. The system may pre-select the most recently selected payer in this session by default. If no payer has previously been selected, then the system may not pre-select a payer from the list-box. For the selected payer, the system may display a page having a list-box that contains all biller system users currently related to the payer and a list-box that contains all biller system users currently unrelated to the payer. The system may provide two buttons to allow users to be added or removed from the related list.

If the biller system administrator selects the adjustments 706 feature, the system may further direct the biller system administrator to selections for performing adjustment tasks including general 725, quantity 726, price 727, and line item allowance 728. When a new biller is created on the channel host, the system may give it a full set of the default adjustments for each of the four types (general, quantity, price, line item allowance). These system may permit these adjustments to be modified, added to, or deleted, allowing full customization by the biller. The system may provide a feature for restoring adjustments to the initial defaults. Selecting the general 725 button may cause the biller system administrator to be directed to a general adjustment codes page 729, wherein the system may permit global general adjustment codes to be edited. At this page 729, the system may display an adjustment list-box and an adjustment information area. The system may permit adjustments to be selected from the list-box to be edited or deleted. The system may permit new adjustments to be added by selecting an add button. The system may make adjustments entered here available to all of the biller's payers in the system. Exemplary associated fields may include: code and description. Selecting the quantity 726 button may cause the system to direct the biller system administrator to a quantity adjustment codes page 730, wherein the system may permit global quantity adjustment codes to be edited. At this page 730, the system may display an adjustment list-box and an adjustment information area. The system may permit adjustments to be selected from the list-box to be edited or deleted. The system may permit new adjustments to be added by selecting an add button. The system may make adjustments entered here available to all of the biller's payers in the system. Exemplary associated fields may include: code, description, threshold amount (which may only be active if “user defined” is not selected), and a “user defined” checkbox. Selecting the price 727 button may cause the system to direct the biller system administrator to a price adjustment codes page 731, wherein the system may permit global price adjustment codes to be edited. At this page 731, the system may display an adjustment list-box and an adjustment information area. The system may permit adjustments to be selected from the list-box to be edited or deleted. The system may permit new adjustments to be added by selecting an add button. The system may make adjustments entered here available to all of the biller's payers in the system. Exemplary associated fields may include: code, description, threshold amount (which may only be active if “user defined” is not selected), and a “user defined” checkbox. Selecting the line item allowance button 728 may cause the system to direct the biller system administrator to a line item allowance adjustment codes page 732, wherein the system may permit global discount adjustment codes to be edited. At this page 732, the system may display an adjustment list-box and an adjustment information area. The system may permit adjustments to be selected from the list-box to be edited or deleted. The system may permit new adjustments to be added by selecting an add button. The system may make adjustments entered here available to all of the biller's payers in the system. Exemplary associated fields may include: code, description, amount (percentage), fixed or scaled, number of days, and a “penalty assessed” checkbox.

The system may permit selection of an edit export templates 733 function for allowing the biller system administrator to edit the templates used in file export in an edit export template section 734. The system may display an export templates listbox showing the present export templates. In the template settings area, the system may display all the attributes and settings of the current selected template. Selecting a template from the export templates listbox may cause the system to populate the fields of the template settings area. In this area, the system may allow the biller system user to add, modify, or delete file export templates by using a set of buttons or controls. The set of invoices to be exported may be based on the invoices that are being viewed at the time export is chosen. The system may permit the user to set that filter through the filter/sort page. The template settings area may contain the following exemplary controls (which, the system may be adapted to store as global information on the database): fields and export order (may contain a listbox of the available invoice fields and an ordered listbox of fields marked for export with two buttons for moving fields between listboxes; via up and down buttons, the system may allow the field export order to be changed); and file formats (a listbox that allows the file format to be selected; if ASCII is chosen a delimiter section may be displayed and the system may require the user to select field and record delimiters). The system may provide a “set default” button for allowing the user to set the current template as the default template for the file export page. By selecting file export, the system may allow the biller system user to export invoices based on an export template. In the templates listbox, the system may show the present export templates, while, in the export range, the system may permit selection of the date range criteria for including invoices in the export. In the templates list, the system may default to the template set as default from the edit export templates page; if no default template was set, the system may pre-select the first entry in the listbox. The system may provide an “export” button for performing the file export and a “cancel” button for aborting.

The system may provide a password/profile change button 735 for directing the biller system administrator to a password/profile change section 736 for changing password and/or profile information.

### Payer System Workflow

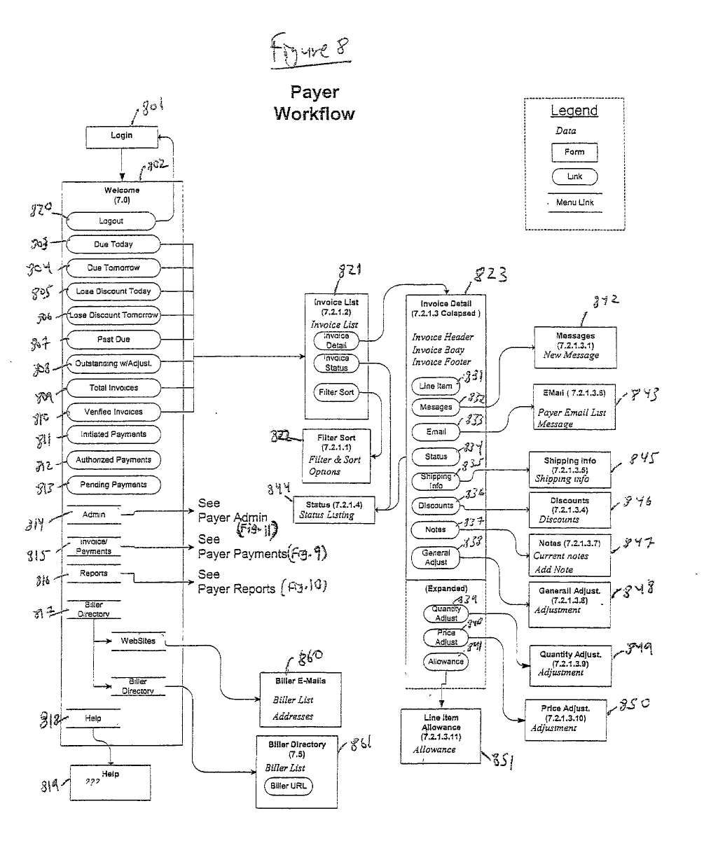

FIG. 8 illustrates an exemplary payer system workflow in one embodiment of the system. When a user logs in 801 to the system using the user ID of a payer, the system may display a payer system administration or “welcome” page 802. The system may display the user's name at the top in the form of a “Welcome ‘Usemame’” message, for personalization. The system may display at a payer system administration page key payer statistics and a list of “action items” with current counts, amounts in local currency and links to the corresponding pages, as well as information about the basic functionality of the main topics. The system may also display at this page information provided by the administrative user regarding how to contact the administrative user. The current counts may include invoices due today, invoices due tomorrow, invoices that will lose a discount today, invoices that will lose a discount tomorrow, invoices past due, invoices outstanding with adjustments, total invoices, verified invoices, initiated payments, authorized payments, and pending payments. The system may provide a selection to the user for filtering and/or sorting the counts. The system may display a biller list, which may include all billers that the payer has a relationship with in the system. The system may permit the payer system user to click on any biller to get a list of invoices from that biller. The system may permit the payer system user to return to this page by clicking on a link that may be present on every page during system access. One area of the screen may contain navigation buttons grouped into categories, e.g., invoices due today 803, invoices due tomorrow 804, invoices that will lose a discount today 805, invoices that will lose a discount tomorrow 806, invoices past due 807, outstanding invoices with adjustments 808, total invoices 809, and verified invoices 810, all of which may link to an invoice list page 821 to display the desired invoices. Other navigation buttons may include initiated payments 811 (which may link to the initiate payment page), authorized payments 812 (which may link to the authorize payment page), pending payments 813 (which may link to the pending payments page), administration 814 (discussed further hereinbelow at “Payer System Administration”), invoices/payments 815, reports 816, and biller directory 817. The system may expand these categories into subcategories that modify another portion of the screen. One area of the navigation frame may contain the user name (not the user ID) who is logged on. The system may allow the user to click on this link to modify his or her basic profile information. The system may provide other functionality, including a “help” button 818 for directing the user to a help section 819 and a “logout” button 820 for logging the current user out of the system.

The system may allow the payer system user to select an option to edit the active user profile, wherein the system may direct the payer system user may be directed to a page displaying the organization name of the payer at the top, to establish the context of the current edit. The system may permit information to be maintained and edited at this page and may store the information as global information on the database, e.g., last name, first, middle, phone, fax, e-mail, e-mail2, password and confirmation. The system may require certain fields for user information, including last name, first name, e-mail and phone. The system may include this information in e-mails which may be sent through the system and may also make this information available to biller and payer system administrators.

If the payer system user selects invoices due today 803, invoices due tomorrow 804, invoices that will lose a discount today 805, invoices that will lose a discount tomorrow 806, invoices past due 807, outstanding invoices with adjustments 808, total invoices 809, or verified invoices 810, the system may direct the payer system user to an invoice list page 821 for displaying invoices which meet the corresponding chosen parameters. At the invoice list page 821, the system may display to the payer system user invoices based on selected criteria and/or allow the payer system user to specify general search criteria for listing invoices. Depending on the selection, the system may direct the user to a “view options” page 822 for filtering and sorting. At the view options page 822, the system may allow the user control over the subset of data that will be displayed and the order in which the data will be presented. To further facilitate the presentation of invoices, the system may automatically save settings associated with a specific report (which may be stored as global information on the database) and allow them to be used again the next time the user generates the report. Considering the time it may take to generate certain reports (e.g. lengthy reports), the system may also provide an option to bring this page up before running a report, to limit the scope and time. The view options page may consist of three exemplary areas: extract, sort and options. In the extract area, the system may provide the following exemplary choices: by date (past due, eligible for discount, due within xxx days); and by status (paid invoices, adjusted invoices, unpaid invoices, paid through another source); and by biller (all biller, specific biller); and by attribute range between xxx and yyy (none, invoice numbers, store/location, purchase orders, purchase request number, invoice issue dates, dollar amount, bill of lading numbers, receiving location zipcodes, invoice aging). The system may also provide the ability to search for invoice number, store or location number, routing number and P.O. number by using wildcards. The system may provide a sort area to allow returned results to be sorted in ascending or descending order according to the following exemplary criteria: due date, invoice number, invoice date, purchase order number, net amount due, store or location number, and invoice aging. In one embodiment, the system may determine sorting criteria and order by a sort order combo box, which may default to ascending, and three sort criteria boxes, the first of which may default to due date, while the rest may default to no sort criteria (spaces). The system may provide an options area with the following exemplary choices: define page size (for displaying invoices in a paging method), remember and use previous settings, and show view options page before presentation. The system may be adapted to store extract, sort, and options data as global information on the database.

The system may allow a payer system user to select an option 821 to list invoices matching specified criteria. The system may display at this screen the filter/sort criteria that are in use for this display. The system may display invoices using a paging concept (i.e. 1-20 of 362). When displaying invoices, the system may remove any existing navigation area, so as to optimize the invoice display area. In one embodiment, the system may display a page separated into two sections, with the header section containing non-scrolling data and/or buttons and the body section that scrolls as necessary, depending upon the width of the browser window and the number of invoices being displayed. The header section may contain the following elements:

The user's selection criteria, i.e., All Invoices—Past due.

The display range text in the format of first—last of maximum, i.e., 1-20 of 200.

“Next ‘n’” may cause the system to navigate the user to the next “n” invoices, i.e., “Next 20”. If the last “n” invoices are currently being displayed the system may disable the “Next” button.

“Previous ‘n’” may cause the system to navigate the user to the previous “n” invoices, i.e., “Previous 20”. If the first “n” invoices are currently being displayed the system may disable the “Previous” button.

“All” may cause the system to change the mode from displaying a page of invoices to displaying all invoices and the system may label the button “Page”, i.e., 1-200 of 200. If the “Page” button is selected, the system may display at this page the first “n” invoices, and the system may label the button “All”.

“Back” may cause the system to return to the previous screen, step, or function.

“Search” may cause the system to perform a search in the current invoice list by using the “Find” feature. The system may permit only the invoices currently being displayed to be searched. The system may allow the user to type a string to search for before selecting the “Search” button. The system may search each invoice for the specified string. If a match is found, the system may scroll the invoice record into view and select the text found. Selecting “Search” again may cause the system to find the next instance of the string. The system may permit wildcard searches.

“Show Selected” may cause the system to display all invoices that have been manually checked. In the last column of the invoice list, the system may allow a user to select individual invoices. While the user remains on this page, the system may maintain in a list all invoices that are marked as selected. If the user switches the context of this view, the system may not remove any selection made by the user. Clicking on the “Show Selected” button may cause the system to display all the invoices the user has selected. The system may change this button may change to either “Page” or “All”, depending on the state of the selection when this button was pressed. Selecting this button again may cause the system to return the invoice list to its previous mode. The system may display all Selected invoices, even if they exceed the page limit.

“Paid Through Another Source” may be provided by the system as an option for the payer system user to mark an invoice as closed by selecting desired invoices and clicking on the “Paid through another source” button. Once this occurs, the system may, for the invoices in question, update their audit trail to reflect that they were paid outside the system, and then change their status to “Closed”.

In the body section, the system may display all invoices in table format. The width of the table columns may be proportional to the width of the browser window. If the browser window is narrowed, the system may decrease column widths appropriately and wrap text within each column, as necessary. If an invoice has adjustments, the system may highlight that line in color to indicate this fact. The system may link the invoice number field to the invoice detail page. The system may link the status field to the invoice history page, at which the system may display a full status history for the selected invoice. By default, the system may display the following exemplary columns: biller name (and/or logo(s)), invoice number, due date, status, net amount due, amount to pay, and select. The payer system administrator may optionally elect to display additional columns (e.g., P.O. number, P.O. requisition number, store number) by setting them in the payer profile (which may be stored as global information on the database).

The system may permit the payer system user to select an option 823 to display the details of a selected invoice, which may cause the system to direct the user to an invoice detail section 610. The system may use one or more predetermined, customizable and/or selectable template schema to format the payer detail, and the system may provide a single payer multiple templates from which to select. The system may present detail using a selected language associated with the selected payer and/or user (which the system may be adapted to store as global information on the database). The invoice detail page may contain various sections. One section may display summary information for the selected invoice, information about the payer, information about the particular invoice, and/or information about the biller. The system may provide selectable buttons for obtaining more information about the current invoice, e.g., items 831, messages 832, e-mail 833, status 834, shipping info 835, discounts 836, and notes 837. The system may display line items that have been adjusted in a different color. Upon selection by a user of the items button 831, the system may toggle the header view from showing a detailed header description to allowing the user to perform basic search operations on the details of this invoice. The items button 831 may cause the system to toggle to header. Clicking on the header button may cause the system to return to the previous view, thereby providing more space for viewing details on the current page, as follows. Another section may contain the line items that make up the invoice. The system may color code highlight line items that have been adjusted. Each line may have a clickable line number. Clicking a line item's number may cause the system to expand the line to show its detail. Clicking a particular adjustment may cause the system to display a window with details about that specific adjustment. Another section may contain the invoice summary. For both the original amount billed and the amount to pay, the system may calculate and display the following: gross total invoice; time conditional discount; other discount/charge; a general adjustments link (which may allow the general adjustment for the current invoice to be entered or edited); sales tax; other tax; and net amount due.

The system may, upon selection of the messages button 832, display a new browser window 842 displaying any messages defined by the biller system administrator for this payer. Selection of the discounts button 834 may cause the system to open a separate browser window 846 displaying additional discount information for the current invoice, including, e.g., time conditional discount %; time conditional discount amount; time conditional discount date; invoice date; and unconditional discount or charge. Selection of the shipping info button 835 may cause the system to display additional shipping information for this invoice in a separate browser window 845, including, e.g., ship to location, date shipped, carrier, bill of lading number, terms, units, unit code, weight, volume, package dimensions, package contents, and notes. In addition to the invoice specific shipping information, the system may list courier websites specified by the biller system administrator as links to the websites of the shipping companies, for shipment tracking or other purposes. Selection of the notes button 837 may cause the system to open a separate browser window 847 containing a list of entered notes for this invoice. In the separate browser window, the system may allow the user to enter new notes into a new note textbox and save them by clicking an “add note” button. Clicking a “cancel” button may cause the system to return the user to the invoice detail page and discard any new notes. Selection of the e-mail button 833 may cause the system to open a separate browser window 843 with a new e-mail referencing the selected invoice. The system may allow the user to enter an e-mail message to selected users about the current invoice. The system may send e-mail to the recipients that are picked from the recipients list (which the system may be adapted to store as global information on the database), the contents of which may be based on the e-mail distribution list set up by the biller system administrator. Selection of the status button 834 may cause the system to open a separate browser window 844 displaying a page containing the status history for the selected invoice, including, e.g., date/time, user ID, and user name and status. The system may further provide adjustment buttons, e.g., general adjustment 838, quantity adjustment 839, price adjustment 840, and allowance 841, at the invoice detail 823 section. The system may permit a general adjustment button 838 to be selected to open a separate browser window 848 containing general adjustment information for this invoice. This information may be read only and may include the following exemplary items of information: adjustment amount, reason code, and notes. The system may permit a quantity adjustment button 839 to be selected for a specific invoice line item, which may cause the system to open a separate browser window 849 containing quantity adjustment information for that line item. This information may be read only and may include the following exemplary items of information: adjustment quantity, reason code, and notes. The system may permit a price adjustment button 840 to be selected for a specific invoice line item, which may cause the system to open a separate browser window 850 containing price adjustment information for that line item. This information may include the following exemplary items of information: new price, reason code, and notes. The system may permit an allowance button 841 to be selected for a specific invoice line item, which may cause the system to open a separate browser window 851 containing allowance information for that line item. This information may be read only and may include the following exemplary items of information: allowance amount, reason code, and notes.

The system may make other options available to the payer system user for selection, e.g. an items button for displaying the invoice details in item view. The system may, upon selection of such a button, remove the header from the invoice details, and all but the net amount due field of the footer, thereby allowing more screen space to be used for the presentation of invoices. The system may provide a search function for performing a search in the current invoice list. The system may permit only the invoices currently being displayed to be searched. The system may allow the user to type a string to search for before selecting the “Search” button. The system may search each invoice may for the specified string. If a match is found, the system may scroll the invoice record into view and select the text found. Selecting “Search” again may cause the system to find the next instance of the string. The system may permit wildcard searches. The system may provide clickable line numbers in the items view line, whereby upon clicking a line item's number, the system may expand the line to show its invoices, and clicking a particular adjustment may cause the system to bring up a window with details about that specific adjustment.

The system may provide other selectable options, including a website button for opening a separate browser window containing links to biller-specific websites, and a biller info button for displaying a new browser window containing the biller information supplied for the current payer.

From the perspective of the payer system user, the system may identify an invoice as having one of the following exemplary states: presented, viewed (an invoice may be considered “viewed” when a invoice display query is built with the invoice included; the user does not necessarily need to actually see the invoice to have it considered viewed), verified (an invoice that is in this state may be rolled back to viewed given the user has the permission to verify), payment initiated, payment authorized, payment pending (an invoice in this state may be rolled back to verified given the user has the permission to authorize payment), paid, and closed.

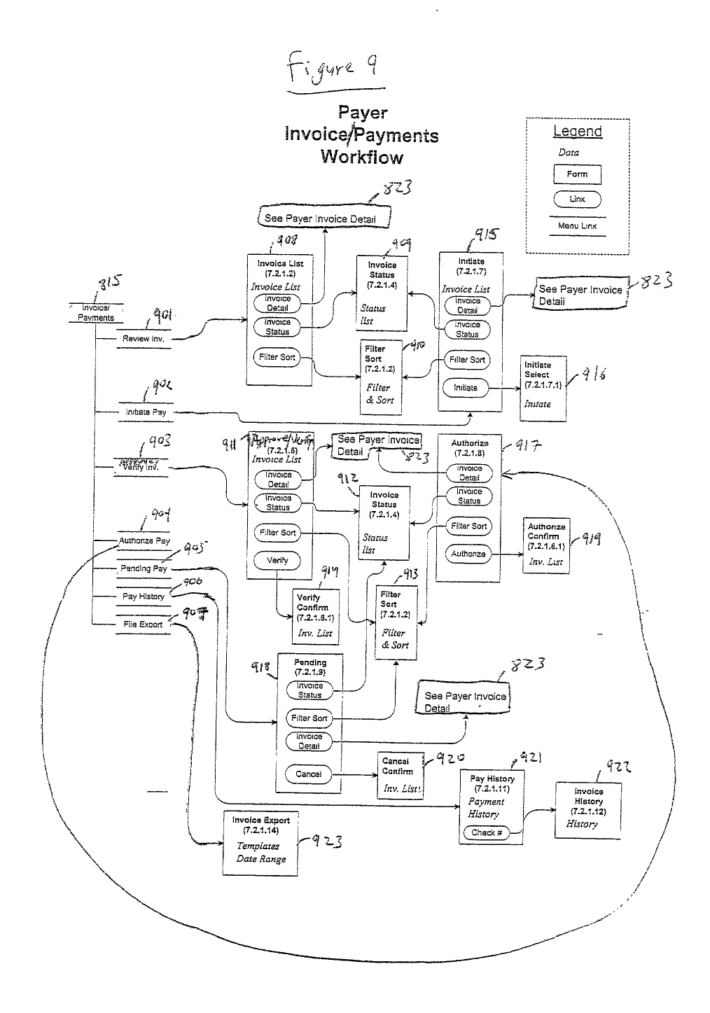

As illustrated in the payer invoice/payments workflow diagram of FIG. 9, if the payer system user selects invoice/payments 815, the system may direct him or her to further select from among invoice/payment selections, which may include, e.g., review invoice 901, initiate payment 902, approve/verify invoice 903, authorize payment 904, pending payment 905, payment history 906, and file export 907.

Selecting the review invoices 901 function may cause the system to direct the user to an invoice list 908, with appropriate links to invoice status 909, detail 823, and sorting 910 pages. The invoice list 908, status 909, detail 823, and sorting 910 pages may be functionally identical to those described above with reference to FIG. 8, at ciphers 821-851.

Selecting the approve/verify invoices 903 function may cause the system to direct the user to an approve/verify page 911 containing an invoice list, with appropriate links to invoice status 923, detail 823, and sorting 913 pages. The invoice list, status 923, detail 823, and sorting 913 pages may be functionally identical to those described above with reference to FIG. 8, at ciphers 821-851. Via the invoice list shown, the system may permit the payer system user to view all invoices in the system that have not yet been approved for payment, subject to the criteria set in the view options page. The system may provide appropriate functionality to approve an individual invoice, approve a selection of invoices, or approve all invoices in the current extract. For any invoice in the extracted set, the system may permit the user to view the corresponding invoice detail page 823 or the invoice status page 923. Invoices included on this page may indicate one of the following exemplary states: presented, viewed, or adjusted. The system may provide appropriate functionality to confirm approval of an individual invoice or group of invoices. The system may permit further selection of an “approve invoices” or “verify confirm” 914 page to permit the user to confirm the requested action.

Selecting the initiate payment 902 function may cause the system to direct the user to an initiate payment page 915 containing an invoice list, with appropriate links to invoice status 909, detail 823, and sorting 910 pages. The invoice list, status 909, detail 823, and sorting 910 pages may be functionally identical to those described above with reference to FIG. 8, at ciphers 821-851. Via the invoice list shown, the system may permit the payer system user to view all invoices in the system that have been approved for payment, subject to the criteria set in the view options page. The system ma provide appropriate functionality to initiate payment for an individual invoice, a selection of invoices, or all invoices in the current extract. For any invoice in the extracted set, the system may also permit the user to view the corresponding invoice detail page 823 or the invoice status page 909. The system may display an “amount to pay” column, the amount shown being net of all applied credits and adjustments. The system may provide appropriate functionality to perform a cancel, which action may cause the system to roll back the status to viewed, detaching any applied credits if necessary. The system may permit the user to toggle between the discount date and the invoice due date. The system may set payment options to the default value established for the current biller/payer relationship. The system may page payments to accurately represent how the payment will be submitted. If the selection contains applied credit notes, the system may render each in a separate payment. The system may further permit the user to select a payment initiation selection page 916 to confirm the requested action, i.e. to confirm payment initiation of selected invoices in the system.

Selecting the authorize payment function 904 may cause the system to direct the user to an authorization page 917 containing an invoice list, with appropriate links to invoice status 912, detail 823, and sorting 913 pages. The invoice list, status 912, detail 823, and sorting 913 pages may be functionally identical to those described above with reference to FIG. 8, at ciphers 821-851. Via the invoice list shown, the system may permit the payer system user to view all invoices in the system that have had payment initiated, subject to the criteria set in the view options page. The system may permit the user to click on any check number to view details for that payment group. The system may further permit the payer system user to select check boxes next to payments to select those payments, and to click on an “authorize” button to authorize those selected payments. The system may further permit the user to click on an “authorize all” button to authorize all payments listed. The payment method may be the payment option selected for this transaction, and the initiator may be the user name of the user who authorized the payment. The system may permit the authorize stage to be automatically bypassed if the payment amount is less than a pre-selected threshold amount. The system may further permit the user to select an authorize payment confirmation page 919 to confirm the requested action, i.e. to confirm payment authorization of selected invoices in the system.

Selecting the pending payments 905 function may cause the system to direct the user to a pending payment page 918 containing an invoice list, with appropriate links to invoice status 912, detail 823, and sorting 913 pages. The invoice list, status 912, detail 823, and sorting 913 pages may be functionally identical to those described above with reference to FIG. 8, at ciphers 821-851. Via the invoice list shown, the system may permit the payer system user to view all pending payments in the system subject to the criteria set in the view options page. The system may permit the user to click on any check number to view details for that payment group. The system may further permit the payer system user to select check boxes next to payments to select those payments, and to click on a “cancel” button to cancel the selected payments. The system may further permit the user to click on “cancel all payments” to cancel all payments listed. Canceling a pending payment may cause the system to roll the transaction back to the “verified” invoice state. The system may further permit the user to select a cancellation confirmation page 920 to confirm the requested action, i.e. to confirm canceling pending payments for selected invoices in the system.

Selecting the payment history 906 function may cause the system to direct the user to a payment history page 921, wherein the user may view all paid invoices in the system, referencing the corresponding check number, subject to the criteria set in the view options page. The system may provide an invoice history page 922, whereby the system may display an invoice history line for each invoice that meets the view options criteria. Selecting an invoice number link may cause the system to display the corresponding invoice detail page (e.g., as shown and described with respect to cipher 823 of FIG. 8). The system may provide an invoice status link for displaying a corresponding invoice status page (e.g. as shown and described with respect to cipher 844 of FIG. 8).

The system may permit the payer system user to select an export files function 907, i.e., to download data directly from the server, bypassing the need to have the data flow through a transmission to the payer system user. Selecting the export files option 907 may cause the system to direct the user to the invoice export section 923, from which the user may either edit export templates or export files. Upon selection of edit export templates, the system may allow the payer system user to edit the templates used in file export. An export templates listbox may shows the present export templates while a template settings area may contain all the attributes and settings of the current selected template. Upon selection of a template from the export templates listbox, the system may populate the fields of the template settings area. In this area, the system may allow the payer system user to add, modify, or delete file export templates (which the system may be adapted to store as global information on the database) by using a set of buttons or controls. The set of invoices to be exported may be based on the invoices that are being viewed at the time export is chosen. The system may permit the user to set that filter through the filter/sort page. The template settings area may contain the following exemplary controls (which the system may be adapted to store as global information on the database): document type, document status, include (headers and/or line items), fields and export order (may contain a listbox of the available invoice fields and an ordered listbox of fields marked for export with two buttons for moving fields between listboxes; up and down buttons may allow the field export order to be changed), file formats (a listbox that allows the file format to be selected; if ASCII is chosen, the system may display a delimiter section and require the user to select field and record delimiters; file formats may include X12 810, “XML 810”, PayBase™, and CSV). The system may provide a “set default” button for allowing the user to set the current template as the default template for the file export page. Upon selecting file export, the system may allow the payer system user to export invoices based on an export template. N the templates listbox, the system may show the present export templates while the export range may allow the user to select the date range criteria for including invoices in the export. The system may provide a “today” checkbox, for aiding in setting the to bounding date to the current date. An “export” button may cause the system to perform the file export, while a “cancel” button may cause the system to abort.

It is noted that the system may further permit a payer system user not only to view adjusted invoices from the invoice detail screen (e.g. FIG. 823, as shown in FIG. 8 and described above), but also to make adjustments to an invoice. In this scenario, from a user interface perspective, the system may allow the original amount to remain, but may change the “amount to pay” to “amount to adjust”. At the bottom of the invoice, the system may add a new line that reflects the unapproved amount to pay, subject to any required approval. The system may also allow credit and debit notes to be entered by a payer system user, whereby credit notes may be entered by a user and/or handled by the system as invoices with a negative dollar amount, and debit notes entered by a user and/or handled by the system as invoices. Thus, the system may permit credit requests to be entered in the same manner as adjustments are entered. If a credit request is issued, the system may send an e-mail to the distribution list for this event, referencing the invoice in question (i.e. invoice number, date, paying company, etc.), amount of credit requested, type of adjustment, adjustment code, and description of need for credit. After an invoice load, the system may execute a process that sets negative dollar invoices to a “verified” status, so that they will appear on the “initiate payment” list. The system may not roll back invoices with a “verified” status and a negative dollar amount to “presented” or “viewed” status. The system may make a report available to certain users listing all outstanding credit notes, including quantity and total dollar amount.

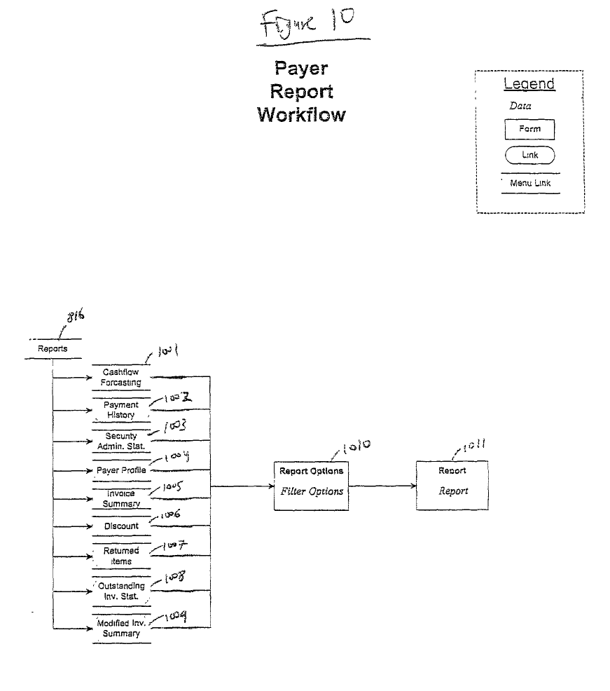

As shown in the workflow diagrams of FIGS. 8 and 10, the system may permit the payer system user to select a reports option 816, which may cause the system to display subcategories that correspond to the available reports for selection. Exemplary reports may include: cashflow forecasting 1001, payment history 1002, security administrator statistics 1003, payer profile 1004, invoice summary 1005, discount 1006, returned items 1007, outstanding invoice statistics 1008, and modified invoice summary 1009. The system may permit the user to select from among various reporting options and/or filters 1010 (which the system may be adapted to store as global information on the database), and the system may then generate a report for viewing and/or printing at a report page 1011.

As shown in the workflow diagram of FIG. 8, the system may permit a payer system user to select a biller directory option for displaying a screen containing options which, when selected, cause the system to direct the user to pages for viewing biller websites and/or e-mail addresses 860 and a biller directory 861 (i.e. a list of available billers in the system). From the biller directory 861, clicking on a biller's company name may cause the system to bring the user to a URL set by the biller system administrator.

### Payer System Administration Workflow

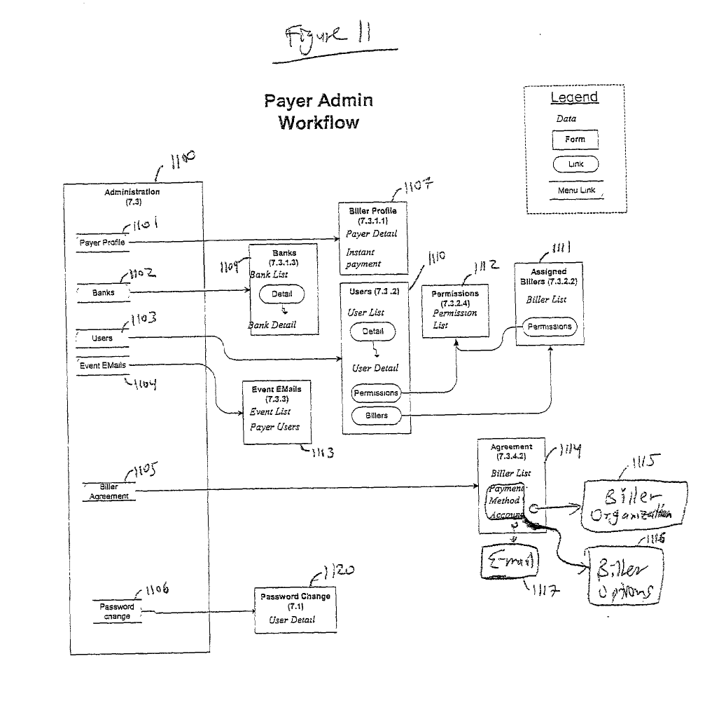

FIG. 11 illustrates an exemplary payer system administration workflow in one embodiment of the system. From the administration 1100 screen, the system may permit a payer system administrator to select from among functions including, e.g., edit payer profile 1101, edit banks 1102, edit users 1103, edit event e-mails 1104, edit biller agreement 1105, and password change 1106.

Upon selection by the payer system administrator of the edit payer profile 1101 function, the system may redirect the payer system administrator to a payer profile section 1107 for editing the payer's profile information. The system may permit company data to be entered and/or edited for the following exemplary fields (which the system may be adapted to store as global information on the database): name, address, city, state, zip, country, SIC code, TIN, organization type, show invoice list columns, language for local country presentation, and currency for payment. The system may provide additional functionality for displaying an “instant payment” interface and a default settlement dates selector. At the instant payment interface, the system may permit the administrator to edit the company's instant payment terms that are used for payment of invoices in the system. The system may allow a payer system administrator to establish a threshold payment amount for instant payment. If an invoice comes in with a value less than the threshold amount, the system may be adapted to immediately initiate and authorize the invoice. When the 810 is loaded, if an invoice is below the threshold amount, the system may immediately create a payment, place it in the pending queue, and initiate an audit trail. Instant payment data (which the system may be adapted to store as global information on the database) may include the following exemplary fields: Instant payment (enabled/disabled), threshold amount, default account, default method of payment, and default settlement date (due date or discount date). The default settlement date may cause the system to provide additional functionality for the payer of having the settlement date by default be the due date to receive discounts. The system may provide the user the ability to change that date.

Upon selection by the payer system administrator of the edit banks 1102 function, the system may redirect the payer system administrator to a payer bank editing section 1109 for allowing the bank information associated with the payer to be edited. It is contemplated that a payer may have multiple banks with each bank having multiple bank accounts. An exemplary edit banks 1109 section may be separated into three sections. In the first section, the system may display a list-box containing all the banks associated with the current payer. Selecting a bank from this list may cause the system to set the context for all other sections and fields of the page. For the selected bank, the system may display in a second section the following exemplary fields (which the system may be adapted to store as global information on the database): name, address, city, state, zip code, country, country#, account # and RTN. The system may use a MOD9 or similar algorithm to verify valid routing numbers. The system may provide a delete button, which may cause the system to display a confirmation message before deleting the selected bank. Selecting a modify button may cause the system to update the existing bank information with the modified data. Selecting an add button may cause the system to add the current bank information as a new bank. The system may require that the bank name and account # be unique. Pressing a “set default” button may cause the system to set the current bank as the default bank for making payments. In a third section, the system may display for the selected bank a “holidays” list-box populated with all bank holidays associated with this bank. Selecting an existing bank holiday from this list box, followed by the selection of a “delete” button, may cause the system to delete the selected bank holiday. The system may provide combo-boxes for month, day and year selection. Selecting an add button may cause the system to add the selected date to the holiday list-box. If a bank is added with, or is caused to have no holidays through later modification, the system may display a warning to the user. The system may be adapted to store holiday data as global information on the database.

The system may permit a payer system administrator to select a “users” 1103 function, wherein the system may direct the administrator to an edit user section 1110. In this section, the system may permit the administrator to add, modify or delete users associated with the current payer. At this page, the system may display the name of the payer at the top to establish the context of the edit. The system may populate a list box with the selected payer system's user names. As the administrator clicks on each user, the system may display the user's information in a user information section. The system may permit the administrator to add a new user to the current payer by entering information into the user information section. The system may require that the combination of last name, middle initial and first name be unique. The system may permit modify and delete operations to be performed on the currently selected user. The system may provide a checkbox for temporarily deactivating a user. Contact information (which the system may be adapted to store as global information on the database) may be maintained, including, e.g., last name, first, middle, phone, fax, e-mail, e-mail2, user ID, password and confirmation. The system may require certain fields for user information, such as last name, first name, e-mail and phone. The system may provide a reset password button for resetting the selected user's password to the default setting. The system may automatically send an e-mail to a new user after they have been added, telling the user that they have 24 hours to log in and change their password or the account will be disabled (e.g. where the password is set to the default of user's last name; the system may permit accounts to be re-enabled by a payer system administrator). The e-mail may also tell the user how to connect and logon to the system. The system may provide an “assigned billers” button for accessing the edit assigned billers page 1111, where the administrator may assign billers to the current user. At this page, the system may display the name of the payer and user at the top to establish the context of the edit. At this page, the system may display a list-box that contains all billers currently assigned to the current user and a list-box that contains all billers currently not assigned to the current user. The system may provide two buttons to allow billers to be added or removed from the assigned list. The system may provide a “permissions” button for permitting access to the permissions page 1112, wherein the system may permit a user's permission scope to be narrowed to an organizational subset of the assigned biller. At this page, the system may allow the administrator to modify permissions associated with the current user. At this page, the system may display the name of the biller and user at the top to establish the context of the edit. At this page, the system may display a list of permissions available to the currently selected user. The system may determine the permissions available by the permissions available to the current administrator. Permissions (which the system may be adapted to store as global information on the database) may be inherited. The system may display in a list of permissions the organizational defined nodes. A single node may be assigned to the user. By default, a user may have full permissions. The system may permit the desired permission set to be selected for the user and then saved with a “save” button. The system may provide a “cancel” button for exiting and discarding all changes. The system may provide a number of pre-defined payer privilege profiles to simplify the security model. The system may permit the administrator user to choose one of these to give a new user a particular set of permissions. From there, the system may allow permissions for that user to be altered. Exemplary pre-defined payer privilege profiles (which may be stored as global information on the database) may include:

Security Administrator: May have all payer profile and administration permissions, including the ability to set-up and delete ID's, bank accounts and the payer profile itself. The system may not allow this ID to be connected to any billers or any processing permissions. The system may permit this ID access to the security administration report only. The system may permit this ID only to be set-up by the system SuperUser.

Receiving Supervisor: May be provided with a button called “adjust an invoice”. With this new button, the system may permit a receiving administrator to be able to review an invoice and make changes. However, the system may restrict change permissions to quantity adjustments only. The system may link or map this type of ID to an individual biller or group of billers.

Purchasing Manager: May be provided with the buttons for list all invoices; approve invoices (keeping all adjustment capabilities intact); pending payments without the cancel payment privilege; invoice history and biller directories. The system may permit all these permissions to be filtered by biller if the ID were assigned to a particular biller or subset of billers.

Payables Administrator: May have permissions for initiate payments, with one new feature, the ability to create a general invoice adjustment only prior to creating a payment order; pending payments without the cancel payment privilege and payment history. The system may permit all these buttons to be filtered by bank account and biller if the ID were assigned to a particular subset of bank accounts and/or billers. The system may assign this ID the following reports: return items.

Payables Manager: May have permissions for authorize payments; pending payments with cancel payment permissions; payment history; invoice history; payer profile and biller directories. The system may allow this role to be filtered using dollar amount and may assign this ID the following reports: return items.

Controller: May have permissions for list all invoices; pending payments without cancel payment permissions; payment history; and invoice history. The system may assign this ID the following reports: cashflow forecasting; outstanding invoices; discount management; adjusted invoice history and security administrator

Cash Manager: May have permissions for pending payments without cancel payment permissions. The system may assign this ID the following reports: cashflow forecasting report.

Payables Systems Administrator: May be responsible for managing the daily file export routine for both unpaid invoices and payments.

Upon selection by the payer system administrator of the event e-mails 1104 function, the system may redirect the payer system administrator to an event e-mail section 1113. In this section, the system may permit a list of payer system users to be associated with specific system events. Any time one of these specific events occurs, the system may generate an automatic e-mail and send it to the selected list of payer system users. For example, exemplary distribution list choices may include: invoices loaded successfully, invoices approved, payment initiated, payment authorized, payment canceled, and payment completed. The system may display at the this page a list-box that contains all payer system users currently in the selected distribution list and a list-box that contains all payer system users currently not in the selected distribution list. In one embodiment, the system may provide two buttons to allow users to be added or removed from the distribution list. The system may allow a default e-mail address to be set up for each event, e.g. the payer system administrator.

Selecting edit biller agreement 1105 may cause the system to direct the payer system administrator to an edit biller agreement page 1114, from which the payer system administrator may access such exemplary pages as biller organization 1115, options 1116, and biller e-mail 1117.

The system may provide a biller organization page 1115 to address the enterprise organizational model, the goal being to simulate the business structure of an enterprise so that the proper people can have access to and see the appropriate information. Although business organizations are hierarchical by definition, this structure may be too complex for the intended system implementation. Moreover, much of what makes up an organizational hierarchy is not passed as an attribute of an invoice transaction. Instead, what may be implemented supports the specificity of the hierarchical organization, while at the same time assuming no structure. For example, a biller organization might consist of company, department, region, division or store units. Assuming that these fields are populated within the invoice transactions of the system, the system may permit permission sets to be defined, each permission set being for assigning and establishing data access rights to specific users. Each permission set may contain one or more uniquely defined combinations. Three exemplary permission sets might be: Set #1 (Store #1, Store #2, Store #3); Set #2 (Store #4, Store #5, Store #6); and Set #3 (Division #1, Division #2). At the biller's organization page, the system may display a list-box containing all the billers related to the current payer. The system may pre-select by default the most recently selected biller in this session. If no biller has previously been selected, then the system may not pre-select any biller from the list-box. For the selected biller, the system may display the list of defined organizational elements or permission sets. The system may provide buttons to add, remove and modify an entry, and may further provide an edit control to allow editing of the name of the entry. The system may display a second list-box containing the specific data values that make up the organizational element for the selected biller. A data value may be made up of the field identifier and the field value. The system may provide a combo-box that allows the user to select the field identifier, and the system may provide an edit control to allow the user to enter the field value. The system may provide buttons to add, remove and modify an entry from this list. The system may be adapted to store biller organization data as global information on the database.

Selecting the options function may cause the system to allow the payer system administrator to establish options for a specific biller using a biller options page 1116. At the biller options page, the system may display a list-box containing all the billers related to the payer. The system may pre-select by default the most recently selected biller in this session. If no biller has previously been selected, the system may not pre-select any biller from the list-box. For the selected biller, the system may display the biller options. Exemplary biller options may include: payment methods and account.

Selecting the biller e-mail function may cause the system to allow the payer system administrator to associate a list of payer system users with a specific biller using a biller e-mail page 1117. At the biller e-mail page, the system may display a list-box with all the billers related to the payer. The system may pre-select the most recently selected biller in this session by default. If no biller has previously been selected, the system may not pre-select any biller from the list-box. For the selected biller, the system may display at this page a list-box that contains all payer system users currently related to the biller and a list-box that contains all payer system users currently unrelated to the biller. The system may provide two buttons to allow users to be added or removed from the related list. The system may be adapted to store the foregoing associations as global information on the database.

The system may provide a password change button 1106, for directing the payer system administrator to a password change section 1120 for changing password information.

### Alternative Embodiments

It will be appreciated by those skilled in the art that although the functional components of the exemplary embodiments of the system of the present invention described herein may be embodied as one or more distributed computer program processes, data structures, dictionaries or other stored data on one or more conventional general purpose computers (e.g. IBM-compatible, Apple Macintosh, and/or RISC microprocessor-based computers), mainframes, minicomputers, conventional telecommunications (e.g. modem, DSL, satellite and/or ISDN communications), memory storage means (e.g. RAM, ROM) and storage devices (e.g. computer-readable memory, disk array, direct access storage) networked together by conventional network hardware and software (e.g. LAN/WAN network backbone systems and/or Internet), other types of computers and network resources may be used without departing from the present invention. One or more networks discussed herein may be a local area network, wide area network, internet, intranet, extranet, proprietary network, virtual private network, a TCP/IP-based network, a wireless network, an e-mail based network of e-mail transmitters and receivers, a modem-based telephonic network, an interactive telephonic network accessible to users by telephone, or a combination of one or more of the foregoing.

The invention as described herein may be embodied in a computer residing on a network transaction server system, and input/output access to the invention may comprise appropriate hardware and software (e.g. personal and/or mainframe computers provisioned with Internet wide area network communications hardware and software (e.g. CQI-based, FTP, Netscape Navigator™ or Microsoft Internet Explorer™ HTML Internet browser software, and/or direct real-time TCP/IP interfaces accessing real-time TCP/IP sockets) for permitting human users to send and receive data, or to allow unattended execution of various operations of the invention, in real-time and/or batch-type transactions. Likewise, the system of the present invention may be a remote internet-based server accessible through conventional communications channels (e.g. conventional telecommunications, broadband communications, wireless communications) using conventional browser software (e.g. Netscape Navigator™ or Microsoft Internet Explorer™). Thus, the present invention may be appropriately adapted to include such communication functionality and internet browsing ability. Additionally, those skilled in the art will recognize that the various components of the server system of the present invention may be remote from one another, and may further comprise appropriate communications hardware/software and/or LAN/WAN hardware and/or software to accomplish the functionality herein described.

Each of the functional components of the present invention may be embodied as one or more distributed computer program processes running on one or more conventional general purpose computers networked together by conventional networking hardware and software. Each of these functional components may be embodied by running distributed computer program processes (e.g., generated using “full-scale” relational database engines such as IBM DB2, Microsoft SQL Server , Sybase SQL Server™, Oracle 7.3™, or Oracle 8.0™ database managers, and/or a JDBC interface to link to such databases) on networked computer systems (e.g. comprising mainframe and/or symmetrically or massively parallel computing systems such as the IBM SB2™ or HP 9000™ computer systems) including appropriate mass storage, networking, and other hardware and software for permitting these functional components to achieve the stated function. These computer systems may be geographically distributed and connected together via appropriate wide- and local-area network hardware and software. In one embodiment, program data may be made accessible to the user via standard SQL queries for analysis and reporting purposes.

Primary elements of the invention may be server-based and may reside on hardware supporting an operating system such as Microsoft Windows NT/2000™ or UNIX. Clients may include a PC that supports Apple Macintosh™, Microsoft Windows 95/98/NT/ME/2000™, a UNIX Motif workstation platform, or other computer capable of TCP/IP or other network-based interaction. In one embodiment, no software other than a web browser may be required on the client platform.

Alternatively, the aforesaid functional components may be embodied by a plurality of separate computer processes (e.g. generated via dBase™, Xbase™, MS Access™ or other “flat file” type database management systems or products) running on IBM-type, Intel Pentium™ or RISC microprocessor-based personal computers networked together via conventional networking hardware and software and including such other additional conventional hardware and software as may be necessary to permit these functional components to achieve the stated functionalities. In this alternative configuration, since such personal computers typically may be unable to run full-scale relational database engines of the types presented above, a non-relational flat file “table” (not shown) may be included in at least one of the networked personal computers to represent at least portions of data stored by a system according to the present invention. These personal computers may run the Unix, Microsoft Windows NT/2000™ or Windows 95/98/ME™ operating systems. The aforesaid functional components of a system according to the present invention may also comprise a combination of the above two configurations (e.g. by computer program processes running on a combination of personal computers, RISC systems, mainframes, symmetric or parallel computer systems, and/or other appropriate hardware and software, networked together via appropriate wide- and local-area network hardware and software).

A system according to the present invention may also be part of a larger computerized financial transaction system comprising multi-database or multi-computer systems or “warehouses” wherein other data types, processing systems (e.g. transaction, financial, administrative, statistical, data extracting and auditing, data transmission/reception, and/or accounting support and service systems), and/or storage methodologies may be used in conjunction with those of the present invention to achieve an overall information management, processing, storage, search, statistical and retrieval solution for a particular lock box service provider, e-payment warehouser, biller organization, financial institution, payment system, commercial bank, and/or for a cooperative or network of such systems.

In one embodiment, source code may be written in an object-oriented programming language using relational databases. Such an embodiment may include the use of programming languages such as C++. Other programming languages which may be used in constructing a system according to the present invention include Java, HTML, Perl, UNIX shell scripting, assembly language, Fortran, Pascal, Visual Basic, and QuickBasic. Those skilled in the art will recognize that the present invention may be implemented in hardware, software, or a combination of hardware and software.

The translation or mapping of EDI-type financial data, particularly of the X12, UN/EDIFACT, and NACHA formats, as discussed herein, is provided herein only as an example of transaction data capable of interacting with the invention and should not be construed so as to limit the use of the invention solely in such a setting. While the discussion herein presumes the use of the invention with respect to EDI, transactional, or financial data, it is anticipated that the invention may have utility in other contexts, as well.

Payment options such as ACH debits, credit or procurement card payments, and/or paper checks may be provided. For ACH debits, a 24 hour settlement window may be required, in which case the payment must be sent to the receiving financial institution 24 hours prior to the settlement date specified by the payer system user. If an ACH debit fails, an ACH return file may be sent from the financial institution, in which case the file is loaded and each transaction may be matched against invoices with the status of paid. When there is a match, the invoice in question may be reopened and rolled back to the status of “verified”. Paper checks may be generated internally or by an external software module, wherein an output file in a format capable of being read by the external module may be generated. Payment by a payer system user using a credit or procurement card may also be effected, to be processed by internet or other means. In this scenario, additional security levels may be included, e.g., for initiating credit card payments (along with a dollar amount limit) and approving credit card payments, and such appropriate credit card payment processing functionality as may be appropriate may be included, as well.

It should also be appreciated from the outset that one or more of the functional components may alternatively be constructed out of custom, dedicated electronic hardware and/or software, without departing from the present invention. Thus, the present invention is intended to cover all such alternatives, modifications, and equivalents as may be included within the spirit and broad scope of the invention as defined only by the hereinafter appended claims.

It should be recognized by those skilled in the art that the present invention may have utility in contexts other than invoice payment, and that the parties to transactions handled by the invention may be entities other than payers and billers/payees in a vendor/vendee context. For example, the invention may be used in bank-to-bank transactions, bank-to-consumer transactions, consumer-to-consumer transactions, and any other financial transactional setting.

Exemplary message definitions and corresponding business objects in one embodiment of the invention are listed in the table below along with a brief description of the functions performed by each, wherein exemplary business objects include AccountMgr, Adjustment, Agreement, Audit, ErrorHandler, FileExport, FinInstMgr, GetFinTrans, GetInvoices, GetPayments, HolidayMgr, InvoiceInfo, LoginManager, MsgManager, and MsgUtils:

| | Business | |
|---|---|---|
| Message | Object | Description |
| AddAccount | AccountMgr | Adds account to a given financial institution. |
| DeleteAccount | AccountMgr | Delete account(s) from financial institution. |
| GetAccountFinInst | AccountMgr | Retrieves financial institution according to account ID. |
| UpdateAccount | AccountMgr | Update a financial institution's account information. |
| AssignBillerAdjustmentCodeList | Adjustment | Take in either a list of Adjustment Code Ids or a set of |
| | | AssignBillerAdjustmentCode messages and add the whole list to the biller ID |
| | | provided |
| RemoveBillerAdjustmentCodeList | Adjustment | Take in either a list of Biller Adjustment Code Ids or a set of |
| | | RemoveBillerAdjustmentCode messages and remove the whole list from the |
| | | biller ID provided |
| AssignPayerAdjustmentCodeList | Adjustment | Take in either a list of Adjustment Code Ids or a set of |
| | | AssignPayerAdjustmentCode messages and add the whole list to the payer ID |
| | | provided |
| RemovePayerAdjustmentCodeList | Adjustment | Take in either a list of Payer Adjustment Code Ids or a set of |
| | | RemovePayerAdjustmentCode messages and remove the whole list from the |
| | | payer ID provided |
| GetPayerAdjustmentCodeList | Adjustment | Return a PayerAdjustmentCodeList of all codes assigned to the payer for a |
| | | given biller |
| GetAdjustmentCodeList | Adjustment | Return an AdjustmentCodeList of all codes that are non-biller specific |
| AddAdjustmentCode | Adjustment | Add a new adjustment code |
| DeleteAdjustmentCode | Adjustment | Delete an existing adjustment code. Does not check to see if assigned |
| | | anywhere else, does not update biller/payer adjustment code tables |
| UpdateAdjustmentCode | Adjustment | Update an adjustment code specified by ID |
| GetGeneralAdjustmentList | Adjustment | Get a GeneralAdjustmentList of all general adjustments for the given Invoice |
| | | ID |
| AddGeneralAdjustment | Adjustment | Add a general adjustment for a given invoice ID, update the agreement |
| | | counters, and mark the invoice as having been adjusted |
| UpdateGeneralAdjustment | Adjustment | Update a general adjustment for a given invoice ID, update the agreement |
| | | counters, and mark the invoice as having been adjusted |
| DeleteGeneralAdjustment | Adjustment | Delete a general adjustment for a given invoice ID, update the agreement |
| | | counters, and check if there are still adjustments for this invoice, else unmark |
| | | the invoice as having been adjusted |
| GetLineItemAdjustmentList | Adjustment | Get a LineItemAdjustmentList for a given LineItemDetail |
| AddLineItemAdjustment | Adjustment | Add a new LineItemAdjustment to the given LineItemDetail by the ID |
| | | provided and update the agreement counters and the grossAdjustedTotal |
| | | amount and the adjusted flag on the invoice |
| DeleteLineItemAdjustment | Adjustment | Delete a LineItemAdjustment from the given LineItemDetail by the ID |
| | | provided and update the agreement counters and the grossAdjustedTotal |
| | | amount and the adjusted flag on the invoice |
| UpdateLineItemAdjustment | Adjustment | Update a LineItemAdjustment for the given LineItemDetail by the ID |
| | | provided and update the agreement counters and the grossAdjustedTotal |
| | | amount and the adjusted flag on the invoice |
| AssignPayerAdjustmentCode | Adjustment | Assign an AdjustmentCode to the given payer Id while also providing the |
| | | biller ID |
| RemovePayerAdjustmentCode | Adjustment | Remove an adjustment code from a payer using the given |
| | | PayerAdjustmentCode ID |
| GetBillerAdjustmentCodeList | Adjustment | Get A BillerAdjustmentCodeList by the provided biller ID |
| AssignBillerAdjustmentCode | Adjustment | Assign / Create an adjustment code for a biller. If an adjustment code is |
| | | provided, it is assumed to be accurate and the relation is set up in the |
| | | BillerAdjustmentCode table. If there is no adjustment code ID provided, the |
| | | info for creating one can be provided for a biller-specific adjustment code and |
| | | it will establish the relation in BillerAdjustmentCode and the entry in |
| | | AdjustmentCode |
| RemoveBillerAdjustmentCode | Adjustment | Remove an adjustment code from a biller. If it is a biller-specific code, also |
| | | remove it from the AdjustmentCode table |
| UpdateBillerAdjustmentCode | Adjustment | Update the values in an existing BillerAdjustmentCode |
| DisplayAdjCode | Adjustment | Get adjustment codes for any biller or agreement |
| AddAgreement | Agreement | Add an agreement for a biller and payer ID combo to the system. Must have |
| | | a biller ID, payerID, customer number, and biller number |
| DeleteAgreement | Agreement | Remove an agreement for a biller and a payer from the system |
| UpdateAgreement | Agreement | Update the values in an agreement |
| GetPayersForBillerNumber | Agreement | Get all of the Payers with agreements for this biller number |
| GetNonPayersForBillerNumber | Agreement | Get all of the Payers who do not have agreements with this biller number |
| GetPayersForBillerID | Agreement | Get all of the Payers with agreements for this biller ID |
| GetNonPayersForBillerID | Agreement | Get all of the Payers who do not have agreements with this biller ID |
| GetBillersForPayerID | Agreement | Get all of the Billers with agreements for this payer ID |
| GetNonBillersForPayerID | Agreement | Get all of the Billers who do not have agreements with this payer ID |
| DeleteAgreementList | Agreement | Remove the agreements for the list of agreement IDs provided |
| GetAgreementList | Agreement | Get agreement list based on any filter |
| GetPayerAgreementList | Agreement | Returns InvoiceReviewUI Entity with payer and agreement info |
| GetBillerAgreementList | Agreement | Returns InvoiceReviewUI Entity with biller and agreement info |
| AddAuditMsgBulk | Audit | Takes a list of audit messages and inserts them into the database. Note audit |
| | | messages can be of type: GENERAL, SYSTEM, SECURITY. |
| AddAuditMsg | Audit | Adds an audit message to the database. Note audit messages can be of type: |
| | | GENERAL, SYSTEM, SECURITY. |
| DeleteAuditMsg | Audit | Deletes an audit message from the database. |
| GetAuditMsgList | Audit | Gets a list of audit messages from the database |
| PostErrorMsg | ErrorHandler | Post an error message via the Selector. |
| PostError | ErrorHandler | Posts an error message directly, without a call through the Selector. The |
| | | function uses ADO to access the database, instead of the standard engine |
| | | calls. |
| ExportUnapprovedInvoicesToCSVFile | FileExport | Exports a list of unapproved invoices to character delimited file format. |
| ExportUnauthorizedPaymentsToCSVFile | FileExport | Exports a list of unauthorized payments to a character delimited file format. |
| ExportUnapprovedInvoicesToXMLFile | FileExport | Exports a list of unapproved invoices to an XML file. |
| ExportUnauthorizedPaymentsToXMLFile | FileExport | Exports a list of unauthorized payments to an XML file. |
| AddFinInst | FinInstMgr | Adds a financial institution to the system. |
| DeleteFinInst | FinInstMgr | Deletes a financial institution from the system. |
| UpdateFinInst | FinInstMgr | Updates a financial institution. |
| GetFinInstList | FinInstMgr | Retrieves a financial institution list for a given biller, or payer. |
| DisplayAccount | FinInstMgr | Get account lists for any filter |
| DisplayBankList | FinInstMgr | Get current bank info |
| GetFinTranList | GetFinTrans | Get a FinTranList. Can either provide where and orderby info or a list of |
| | | FinTranIds |
| GetFinTran | GetFinTrans | Get a specific FinTran by ID |
| GetFinTranReviewList | GetFinTrans | A light UI based method for getting FinTrans with a single invoice and |
| | | payment |
| GetInvoiceList | GetInvoices | Get an InvoiceList. Can either provide where and orderby info or a list of |
| | | Invoice Ids |
| GetInvoicesForPayment | GetInvoices | Get an InvoiceReviewUIList for a given paymentId |
| GetInvoiceHistory | GetInvoices | Get a FinTranList for payments which were batched more than 60 days ago, |
| | | then display the invoices for them |
| GetInvoiceReviewList | GetInvoices | Get a InvoiceReviewUIList. Can either provide where and orderby info or a |
| | | list of Invoice Ids |
| GetInvoice | GetInvoices | Get a specific Invoice by ID |
| GetPaymentReviewList | GetPayments | Get a PaymentReviewUIList. Can either provide where and orderby info or a |
| | | list of Payment Ids |
| GetPaymentList | GetPayments | Get a FinTranList. Can either provide where and orderby info or a list of |
| | | PaymentIDs. Used FinTranList so Xpath filter could work against any |
| | | criteria under it |
| GetPaymentHistory | GetPayments | Get a FinTranList for payments which were batched more than 60 days ago, |
| | | then display the payments for them |
| AddHoliday | HolidayMgr | Adds a holiday to a specified financial institution. |
| UpdateHoliday | HolidayMgr | Updates a holiday entry in the database with new information. |
| DeleteHoliday | HolidayMgr | Removes a holiday from a financial institution. |
| GetHolidayList | HolidayMgr | Gets a list of holidays for a given financial institution. |
| ValidateSettlementDate2 | HolidayMgr | This function can be called directly from any component without the Selector. |
| | | It takes a date, and a financial institution ID. If the date is a holiday or a |
| | | weekend then the next possible workday is returned. Otherwise the original |
| | | date is returned in string form. |
| ValidateSettlementDate | HolidayMgr | If the date is a holiday or a weekend then the next possible workday is |
| | | returned. Otherwise the original date is returned in the XML message |
| | | parameter. |
| GetInvoiceCountsForUser | InvoiceInfo | Get invoice counts for the following: |

Invoices due today, Invoices due tomorrow, Invoices that lose discount

| | | |
|---|---|---|
| | | today, Invoices that lose discount tomorrow, and Invoices that are past due. |
| | | Uses the stored proc GetInvoiceInfo and passes back the counts and the |
| | | Xpath to select the data set which is placed in the payer front screen |
| | | hyperlinks for the counts |
| GetInvoiceStatusList | InvoiceInfo | Get the InvoiceStatus change entries for a given Invoice ID |
| AddInvoiceStatus | InvoiceInfo | Add a new InvoiceStatus record for an invoice ID |
| Login | LoginManager | Logs a user into the system, passing it a user name, and password. The user |
| | | will be authenticated against his/her domain credentials as well as the |
| | | NetTransact database information. |
| Logoff | LoginManager | User logs off according to his/her session ID. A session ID is needed as part |
| | | of the formal message command. |
| DispatchMsg | MsgManager | Dispatches a message to the selector. If session information is needed, then |
| | | the parameters in the original message body are filled in. |
| GetPayerBillerAdjustmentCodesWithAssigned | MsgUtils | Get a BillerAdjustmentCodeList for the biller supplied, match the |
| | | PayerAdjustmentCodes for the payer supplied to the BillerAdjustmentCodes |
| | | and set the assigned attribute on the BillerAdjustmentCodeList where there is |
| | | a match. Gives a single list for what biller adjustment codes are available and |
| | | which have been assigned to the payer |
| GetPayerAdjustmentCodesWithAssigned | MsgUtils | Get all AdjustmentCodes in an AdjustmentCodeList and match the |
| | | PayerAdjustmentCodes for the payer supplied to the AdjustmentCodes and |
| | | set the assigned attribute on the AdjustmentCodeList where there is a match. |
| | | Gives a single list for what adjustment codes are available and which have |
| | | been assigned to the payer |
| GetBillerAdjustmentCodesWithAssigned | MsgUtils | Get all AdjustmentCodes in an AdjustmentCodeList and match the |
| | | BillerAdjustmentCodes for the biller supplied to the AdjustmentCodes and |
| | | set the assigned attribute on the AdjustmentCodeList where there is a match. |
| | | Gives a single list for what adjustment codes are available and which have |
| | | been assigned to the biller |

What is claimed is:

1. A method for electronic bill presentment and payment comprising:
storing global information relating to a biller system and a payor system;
storing at least one modular business object containing specified instructions to govern financial transactions between said biller system and said payor system based on said global information;
permitting said biller system and/or payor system to access said at least one business object for executing a financial transaction; and
permitting replacement of said business object with another modular business object containing other specified instructions using the same said global information.

2. A method for electronic bill presentment and payment comprising:
storing global information relating to a biller system and a payor system;
storing at least one modular business object containing specified instructions to modify said global information; and
permitting replacement of said business object with another modular business object containing other specified instructions for modifying the same said global information.

3. A method as claimed in claim 1, further comprising:
receiving invoice data from said biller system and storing said invoice data on a database.

4. A method as claimed in claim 1, further comprising:
permitting said payor system and/or said biller system to select one said business object for execution and executing said business object.

5. A method as claimed in claim 1, further comprising permitting a business service provider system to access said payment processing system;
said business service provider system configured to provide business processing services to said biller system and said payor system via said payment processing system.

6. A method as claimed in claim 3, further comprising sending an e-mail message to said payor system to alert said payor system of updated invoice data received from said biller system.

7. A method as claimed in claim 1, further comprising providing said payor system and/or biller system access to said at least one business object via a web server.

8. A method as clamed in claim 4, further comprising receiving messages from said selected business object in an extensible markup language format.

9. A method as claimed in claim 8, further comprising structuring and generating calls to said database for execution in standard query language format, based on said extensible markup language formatted messages received from said selected business object.

10. A method as claimed in claim 9, further comprising receiving from said database responses to said standard query language formatted calls.

11. A method as claimed in claim 10, further comprising structuring and generating messages to said selected business object in an extensible markup language format, based on said database responses.

12. A method as claimed in claim 3, further comprising translating invoice data received from said biller system prior to storage on said database.

13. A method as claimed in claim 1, wherein said business object is selected from the group consisting of: an object for reviewing invoices, an object for making adjustments to invoices, and an object for initiating invoice payment.

14. A method as claimed in claim 1, wherein said payment processing system is capable of connection to a network, and wherein said biller system and said payor system comprise hardware and software for connecting to said payment processing system via said network.

15. A method as claimed in claim 5, wherein said business service provider system comprises hardware and software for connecting to said payment processing system via a network.

16. A method as claimed in claim 14, wherein said network is selected from the group consisting of: local area network, wide area network, internet, intranet, extranet, a TCP/IP-based network, a wireless network, an e-mail based network of e-mail transmitters and receivers, a modem-based telephonic network, and an interactive telephonic network accessible to users by telephone.

17. A method as claimed in claim 16, further comprising performing an action via said network selected from the group consisting of: transmitting to said payor system said invoice data, adjudicating said invoice data, allowing said payor system to pay said biller system, and one or more of the foregoing actions in combination.

18. A method as claimed in claim 15, wherein said network is selected from the group consisting of: local area network, wide area network, internet, intranet, extranet, a TCP/IP-based network, a wireless network, an e-mail based network of e-mail transmitters and receivers, a modem-based telephonic network, and an interactive telephonic network accessible to users by telephone.

19. A method as claimed in claim 14, further comprising receiving data and commands from said biller system and said payor system via said network and storing said data and commands in computer-readable memory.

20. A method as claimed in claim 1, further comprising employing a security mechanism for restricting unauthorized access.

21. A method as claimed in claim 20, wherein said security mechanism is selected from the group consisting of: a digital signature, a PIN number, a password, a master key, and one or more of the foregoing in combination.

22. A method as claimed in claim 1, further comprising employing at least one firewall.

23. A method as claimed in claim 1, further comprising storing a mirror copy of said data stored on said database and permitting access to said mirror copy of said data in the event said original data is corrupt or unavailable.

24. A method as claimed in claim 7, further comprising permitting said payor system and/or biller system to access said payment processing system via a web browser.

25. A method as claimed in claim 5, further comprising permitting said business service provider system to access said payment processing system via a web browser.

26. A method as claimed in claim 3, wherein said invoice data comprises at least one payor system, at least one invoice stream, and at least one biller system identifier.

27. A method as claimed in claim 1, further comprising employing access control comprising a list of users, and a user identification and password for each user.

28. A method as claimed in claim 27, wherein said access control is operable to govern whether a user is permitted to access each said business object.

29. A method as claimed in claim 1, wherein said application server further comprises a business function selection object.

30. A method as claimed in claim 3, further comprising utilizing an invoice loader to perform said receipt of said invoice data and said storage of said invoice data on said database.

31. A method as claimed in claim 1, further comprising permitting said biller system to access said payment processing system via a non-browser XML-enabled application.

32. A method as claimed in claim 1, further comprising permitting said payor system to access said payment processing system via a non-browser XML-enabled application.

33. A method as claimed in claim 5, further comprising permitting said business service provider system to access said payment processing system via a non-browser XML-enabled application.

34. A method as claimed in claim 1, wherein said global information is stored on a database.
